(19) United States
(12) Patent Application Publication
(10) Pub. No.: US 2011/0319208 A1
(43) Pub. Date: Dec. 29, 2011

(54) Belt/chain drive system

(76) Inventor: William Bruce Morrow, Santa Barbara, CA (US)

(21) Appl. No.: 12/803,391

(22) Filed: Jun. 24, 2010

(51) Int. Cl. F16H 7/02

(52) U.S. Cl. 474/84

(57) ABSTRACT

In a belt/chain drive system, pairs of drive wheels provided with a helical cut spline on the inner diameter of the drive wheels are mounted on a drive shaft provided with helical cut splines on the outer diameter of the drive shaft. The pairs of drive wheels engage via pairs of closed loop belts/chains pairs of driven wheels provided with a helical cut spline on the inner diameter of the driven wheels mounted on a driven shaft provided with helical cut splines on the outer diameter of the driven shaft. In operation, there is equal load sharing among drive wheels and driven wheels.

### FIELD OF THE INVENTION

The present invention is directed to a belt/chain drive system used for power transmission employing dual helical load sharing, wherein during operational power transmission, paralleled belt/chain drive trains are evenly loaded.

### BACKGROUND OF THE INVENTION

Toothed belt/chain drive systems used for power transmission have several advantages over conventional gear train transmission systems in certain applications. Toothed belt/chain drive systems allow similar per stage speed increase/decrease ratios as convention gear trains. Toothed belt/chain drive systems permit greater separation of input and output shafts than gear-based systems. Furthermore, toothed belt/chain drive systems are usually lighter in weight and less expensive than gear-based systems as heavy gear box cases needed for precise gear alignment is not required. Since there is an inherent flexibility in both toothed belts and chains, toothed belt/chain drive systems are more tolerant of parallel input-output shaft misalignment. Therefore, toothed belt/chain drive systems generally require simpler, less expensive and less precise manufacture and assembly than gear trains.

Toothed belt/chain drive systems require that the ratio of the toothed belt/chain width to the diameter of the toothed drive wheel pulley/toothed driven wheel pulley be within certain limits, typically below about 1.5:1. If this ratio is exceeded, load sharing across the width of the toothed belt/chain deteriorates to such an extent that increasing the width of the toothed belt/chain adds nothing to the load bearing capacity of the toothed belt/chain. Therefore, if greater load is required, one cannot simply employ wider toothed belts/chains and pulleys. To increase load capacity, one must increase pulley diameters to permit wider, and therefore stronger, toothed belts/chains, while keeping the width to diameter ratio below the above discussed value. Ideally, one would like to increase the power or the load transmission capacity of a toothed belt/chain drive system by adding more parallel toothed belts/chains. However, providing even load sharing among multiple parallel toothed belt/chain drive trains is problematic due to inherent variations in toothed belt/chain lengths, uneven stretch and uneven chain link or belt tooth wear. Likewise, manufacturing tolerances in the manufacture of drive wheels, driven wheels and the toothed belts or chains lead to uneven load sharing problems. These problems would result in one or more of the multiple toothed belt/chain drives being loaded higher than the design load with premature failure due to excessive load or wear.

A similar problem arises in gear transmissions if one mounts multiple drive gears on a common drive shaft and multiple driven gears on a common driven shaft in order to obtain increased load transmission. Due to manufacturing tolerances, multiple gears on a drive shaft are not likely to be perfectly aligned with multiple gears on a driven shaft. There is uneven loading on mating drive and driven gears. This problem in prior art gear transmissions was first solved by the present inventor as disclosed in U.S. Pat. No. 5,927,147 to Morrow titled Power Sharing Gear Sets, the entire disclosure of which is incorporated by reference herein. U.S. Pat. No. 5,927,147 is directed to a gear transmission wherein pairs of helical gears (a helical gear being a gear having a helical cut on the outer diameter of the gear) are mounted on a drive shaft for rotation by the drive shaft and axial movement on the drive shaft. The pairs of helical gears mounted on the drive shaft engage corresponding pairs of helical gears mounted on a driven shaft for rotating the driven shaft and for axial movement on the driven shaft. U.S. Pat. No. 5,927,147 achieves even load sharing amongst engaging gears. U.S. Pat. No. 5,927,147 does not include the use of helical cut splines on the drive and driven shafts.

### OBJECTS OF THE INVENTION

It is an object of the present invention to provide even load sharing among multiple parallel belt/chain drive trains.

It is another object of the present invention to provide a belt/chain drive system that can transmit high torque when design considerations in the intended operating environment of the belt/chain drive system limits the diameter of the drive wheel pulleys/driven wheel pulleys.

It is a further object of the present invention to provide a belt/chain drive system having pairs of drive wheels mounted on a spline helical cut drive shaft and pairs of corresponding driven wheels mounted on a spline helical cut driven shaft with a closed loop belt/chain engaging the outer diameter of each corresponding drive wheel and driven wheel of each pair for transmitting rotational power from each drive wheel to a respective driven wheel. During operational power transmission, each drive wheel and each driven wheel and the respective closed loop belt/chain is evenly loaded. Such even loading is attained without the need for precise manufacturing tolerances. Such even loading is attained by a mechanical design that is industrially practical and cost effective to manufacture.

It is yet another object of the present invention to provide a belt/chain drive system wherein the even loading of drive wheels and driven wheels mounted on a spline helical cut drive shaft and a spline helical cut driven shaft and respective closed loop belts/chains results in reduced wear on the drive wheels and driven wheels and respective closed loop belts/chains, thus greatly extending periods between scheduled maintenance and down time for repair.

These and other objects of the present invention will become apparent from the following description and claims read in conjunction with the drawings.

### SUMMARY OF THE INVENTION

The present invention is directed to a belt/chain drive system having pairs of drive wheels, preferably toothed drive wheels, or sprockets mounted on a spline helical cut drive shaft and pairs of driven wheels, preferably toothed driven wheels, or sprockets mounted on a parallel spline helical cut driven shaft with a respective closed loop belt/chain engaging an outer diameter of each drive wheel and an outer diameter of each driven wheel for transmitting rotational power from each respective drive wheel to each respective driven wheel. In operation, the present invention achieves even load sharing among each respective drive wheel and driven wheel and the corresponding closed looped belt/chain.

The closed loop belt/chain will cause the spline helical cut driven shaft to rotate in the same direction as rotation of the spline helical cut drive shaft.

In the present invention, the term belt/chain means a belt, preferably a toothed belt, or a chain or a band or a similar device which transmits power or torque from a drive wheel, preferably a toothed drive wheel, or sprocket on a drive shaft to a driven wheel, preferably a toothed driven wheel, or sprocket on a driven shaft. The term drive wheel includes a sprocket or similar device and the term driven wheel includes a sprocket or similar device.

In accordance with the present invention, a helical cut spline on the inner diameter of each drive wheel engages a matching helical cut spline on the outer diameter of the drive shaft. A helical cut spline on the inner diameter of each driven wheel engages a matching helical cut spline on the outer diameter of the driven shaft. The angle and the sense or hand of the helical cut spline on the inner diameter of a drive wheel is equal to or the same as the angle and the sense or hand of the helical cut spline on the outer diameter of the drive shaft engaged by the helical cut spline on the inner diameter of the respective drive wheel. The angle and the sense or hand of the helical cut spline on the inner diameter of a driven wheel is equal to or the same as the angle or sense or hand of the spline helical cut on the outer diameter of the driven shaft engaged by the helical cut spline on the inner diameter of the respective driven wheel.

The angle of helical cut spline on the inner diameter of corresponding drive wheels and corresponding driven wheels is the same but of opposite sense or hand.

The drive wheels are mounted on the spline helical cut drive shaft for rotation by the drive shaft. The drive wheels are also mounted on the spline helical cut drive shaft for axial movement on the spline helical cut drive shaft. The driven wheels are mounted on the spline helical cut driven shaft for rotating the spline helical cut driven shaft in response to rotation of the drive wheels and the engagement of the outer diameter of respective drive wheels and respective driven wheels with a respective closed loop belt/chain. The driven wheels are also mounted on the spline helical cut driven shaft for axial movement on the spline helical cut driven shaft.

In one embodiment of the present invention, the spline helical cut drive shaft is rotated in the counter-clockwise direction. The angles of the helical cut on the inner diameter of the drive wheels mounted on the spline helical cut drive shaft have an opposite hand on adjacent drive wheels of a drive wheel pair such that adjacent drive wheels of a drive wheel pair are pushed together in the axial direction due to axial thrust caused by counter-clockwise rotation of the spline helical cut drive shaft. The angle of the helical cut on the inner diameter of the driven wheels mounted on the spline helical cut driven shaft have an opposite hand on adjacent driven wheels of a driven wheel pair such that the adjacent driven wheels of a driven wheel pair separate and spread by movement of each driven wheel in the driven wheel pair in opposite axial directions due to axial thrust resulting from counter-clockwise rotation of the spline helical cut driven shaft caused by the engaging the closed loop belt/chain. In one embodiment of the present invention, there can be one pair of drive wheels mounted on the spline helical cut drive shaft and one pair of driven wheels mounted on the spline helical cut driven shaft.

In another embodiment of the present invention, due to manufacturing tolerances of the drive and driven wheels and inherent variations in the belts/chains, upon the start of counter-clockwise rotation of the spline helical cut drive shaft, if there are more than one pair of drive wheels/driven wheels, one pair of drive wheels on the spline helical cut drive shaft will establish contact with the corresponding belts/chains and begin transmitting torsional load to a corresponding engaging driven wheel pair on the spline helical cut driven shaft and establish axial thrust forces due to the torsional loading prior to another drive wheel/driven wheel pair so engaging. This first pair of drive wheels on the spline helical cut drive shaft are pushed together in the axial direction due to axial thrust caused by the counter-clockwise rotation of the spline helical cut drive shaft. The first pair of driven wheels on the spline helical cut driven shaft, which mate with corresponding belts/chains, start to spread with each adjacent driven wheel of the driven wheel pair moving axially on the spline helical cut driven shaft in opposite directions. Due to the spreading of this pair of driven wheels on the spline helical cut driven shaft, there is no immediate rotation of this pair of driven wheels on the spline helical cut driven shaft and no loading of the spline helical drive shaft.

Continued counter-clockwise rotation of the spline helical cut drive shaft causes a second pair of drive wheels on the spline helical cut drive shaft to establish contact with the corresponding belts/chains. The pair of drive wheels/driven wheels that is the second to engage with corresponding belts/chains is a function of inherent variations and the manufacturing tolerances. The pair of drive wheels on the spline helical cut drive shaft of this second set of drive wheel/driven wheel pairs are pushed together in the axial direction of the spline helical cut drive shaft due to axial thrust caused by the counter-clockwise rotation of the spline helical cut drive shaft. The pair of driven wheels on the spline helical cut driven shaft of this second set of drive wheel/driven wheel pairs start to spread and separate in the axial direction in the manner previously described.

Again, due to the spreading of the pair of the driven wheels on the spline helical cut driven shaft, there is no immediate rotation of the driven wheels on the spline helical cut driven shaft and no appreciable loading of the spline helical cut drive shaft.

In accordance with the present invention, there can be multiple pairs of drive wheels mounted on the spline helical cut drive shaft and corresponding multiple pairs of driven wheels mounted on the spline helical cut driven shaft.

Counter-clockwise rotation of the spline helical cut drive shaft continues until all pairs of drive wheels/driven wheels on the spline helical cut drive shaft and spline helical cut driven shaft engage with corresponding belts/chains, adjacent drive wheels of all pairs of drive wheels on the spline helical cut drive shaft are pushed together in the axial direction of the spline helical cut drive shaft, adjacent driven wheels of all pairs of driven wheels on the spline helical cut driven shaft start to spread in the axial direction of the spline helical cut driven shaft, and the two outermost driven wheels on the spline helical cut driven shaft are forced by this spreading against retainer members on the spline helical cut driven shaft. The counter-clockwise rotation of the spline helical cut drive shaft then becomes loaded and starts counter-clockwise rotation of the spline helical cut driven shaft. The driven wheels pairs on the spline helical cut driven shaft adjust their separation to balance load and the drive wheel pairs on the spline helical cut drive shaft center themselves with their corresponding engaging belts/chains to balance load transmission.

The system is self balancing and there is even load sharing amongst all the drive wheels and driven wheels and corresponding belts/chains. It will be appreciated that the amount of axial movement of the drive and driven wheels on their respective shafts is small compared to the dimensions of the wheels and lengths of toothed belts/chains. Nonetheless, the axial movement of the drive wheel and its corresponding driven wheel required for load sharing are in opposite directions, and would force a misalignment of a toothed belt, were that belt axially fixed on the drive and driven wheels. In practice, the width of the toothed portion of a toothed wheel is greater than the width of a toothed belt, and hence allows the toothed belt to slide axially on the toothed drive and driven wheels thereby allowing the required relative axial movement between the drive and driven wheels on their respective shafts without causing misalignment of the toothed belt. For a roller chain drive system, the chain is axially fixed by the teeth on the drive and driven wheels or sprockets. However, in practice, roller chains have sufficient flexibility in the axial direction to accommodate the minor relative axial movement of the drive and driven wheels or sprockets required for load sharing.

It will be appreciated that, in accordance with the present invention, the spline helical cut drive shaft can be rotated in the clockwise direction and the spline helical cut driven shaft then rotates in the clockwise direction. It will be further appreciated that, in accordance with the present invention, the adjacent drive wheel of each pair of drive wheels mounted on the spline helical cut drive shaft can separate and spread in the axial direction of the spline helical cut drive shaft and the adjacent driven wheels of each pair of driven wheels mounted on the spline helical cut driven shaft can be pushed together in the axial direction of the spline helical cut driven shaft. The principle of operation, in accordance with the present invention, would be the same.

### BRIEF DESCRIPTION OF THE DRAWINGS

In the drawings forming part hereof:

FIG. 1 is a schematic view, with parts cut away, of one embodiment of a belt/chain drive system in accordance with the present invention illustrating pairs of toothed drive wheels mounted on a spline helical cut drive shaft and pairs of toothed driven wheels mounted on spline helical cut driven shaft prior to commencement of rotation of the spline helical cut drive shaft;

FIG. 2 is a schematic view of one embodiment of a spline helical cut drive shaft in accordance with the present invention used in the embodiment of the belt/chain drive system of the present invention illustrated in FIG. 1;

FIG. 3 is a schematic view of one embodiment of a spline helical cut driven shaft in accordance with the present invention used in the embodiment of the belt/chain drive system of the present invention illustrated in FIG. 1;

FIG. 4 is a schematic view of the embodiment of the belt/chain drive system in accordance with the present invention illustrated in FIG. 1 prior to commencement of rotation of the spline helical cut drive shaft, without parts cut away;

FIG. 5 is a schematic view of the belt/chain drive system of the embodiment of the present invention illustrated in FIG. 1 and FIG. 4 wherein rotation of the spline helical cut drive shaft has just commenced and one pair of driven wheels on the spline helical cut driven shaft have engaged via respective toothed belts with the corresponding pair of drive wheels on the spline helical cut drive shaft and the driven wheels of the driven wheel pair have started separation in the axial direction of the spline helical cut driven shaft (distance of separation greatly exaggerated), this being prior to appreciable loading of driven wheels on the spline helical cut driven shaft with resulting rotation of the spline helical cut driven shaft;

FIG. 6 is a schematic view of the belt/chain drive system of the embodiment of the present invention illustrated in FIG. 1 and FIG. 4 wherein rotation of the spline helical cut drive shaft has proceeded to where both corresponding pairs of drive/driven wheels on both the spline helical cut drive shaft and spline helical cut driven shaft are fully engaged with respective toothed belts and torsionally loaded to cause adjacent drive wheels of both pairs of drive wheels on the spline helical cut drive shaft to be pushed together in the axial direction of the spline helical cut drive shaft and to cause adjacent driven wheels of both pairs of driven wheels on the spline helical cut driven shaft to be separated in the axial direction of the spline helical cut driven shaft at a distance (distance of separation greatly exaggerated) resulting in even loading of the drive wheels/driven wheels and rotation of the driven shaft;

FIG. 7 is a schematic cross-sectional view along line A-A¹ of FIG. 4;

FIG. 8 is a schematic cross-sectional view, along line B-B¹ of FIG. 4;

FIG. 9 is a schematic cross-sectional view along line C-C¹ of FIG. 4;

FIG. 10A is a schematic view of another embodiment of a spline helical cut drive shaft in accordance with the present invention;

FIG. 10B is a schematic view of another embodiment of a spline helical cut driven shaft in accordance with the present invention;

FIG. 11 is a schematic view of an alternative embodiment of the belt/chain drive system of the present invention for use with only two pairs of drive wheels and two pairs of driven wheels at the time of equal loading among all the drive wheels and all the driven wheels;

FIG. 12 is a schematic view of an embodiment of a spline helical cut drive shaft in accordance with the present invention for use in the embodiment of the belt/chain drive system of the present invention illustrated in FIG. 11;

FIG. 13 is a schematic view of an embodiment of a spline helical cut driven shaft in accordance with the present invention for use in the embodiment of the belt/chain drive system of the present invention illustrated in FIG. 11.

### DETAILED DESCRIPTION

In order to provide a more complete understanding of the present invention and an appreciation of its advantages, a detailed description of preferred embodiments is now provided with reference to the drawings.

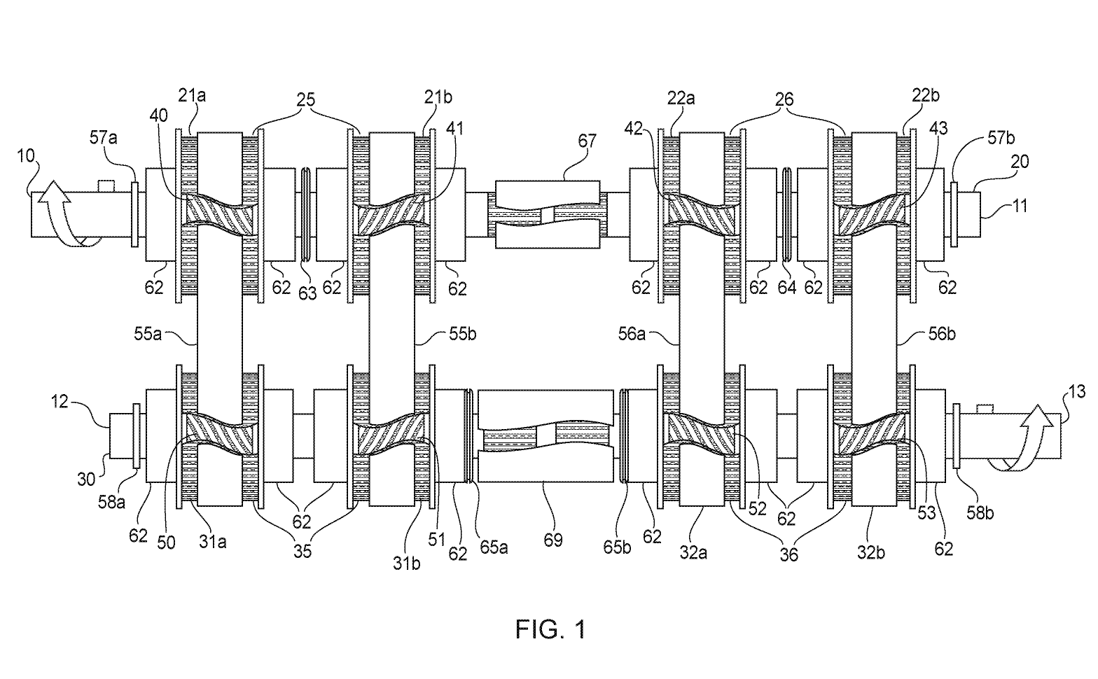

FIGS. 1 to 6 schematically illustrate one embodiment of a belt/chain drive system in accordance with the present invention using a closed loop toothed belt. The belt/chain drive system of the present invention may also be referred to as a pulley drive system. As used in the description and in the claims which follow, the term belt/chain means a belt, preferably a toothed belt, or a chain or a band or similar device which transmits power or torque from a drive wheel (or drive pulley) on a drive shaft to a driven wheel (or driven pulley) on a driven shaft. As used in the description and claims which follow, the term drive wheel includes sprockets or similar devices and the term driven wheel includes sprockets or similar devices.

The present invention will be described in the following description with reference to a closed loop belt having teeth on the interior surface of the belt engaging teeth on the outer diameter of a toothed drive wheel and teeth on the outer diameter of a toothed driven wheel. It will be appreciated that the toothed belt could be a chain having chain links engaging teeth on an outer diameter of a toothed drive wheel and teeth on the outer diameter of a toothed driven wheel. Likewise, the toothed belt used in the present invention could be a band or similar device having teeth or a similar device engaging teeth on the outer diameter of a toothed drive wheel and teeth on an outer diameter of a toothed driven wheel. Furthermore, one skilled in the art could provide devices, other than teeth, on the outer diameter of drive wheels and driven wheels to engage a belt/chain for power transmission from a drive wheel to a driven wheel. Likewise, one skilled in the art could provide devices, other than teeth, on a belt or band or similar device for engaging the outer diameter of a drive wheel and a driven wheel.

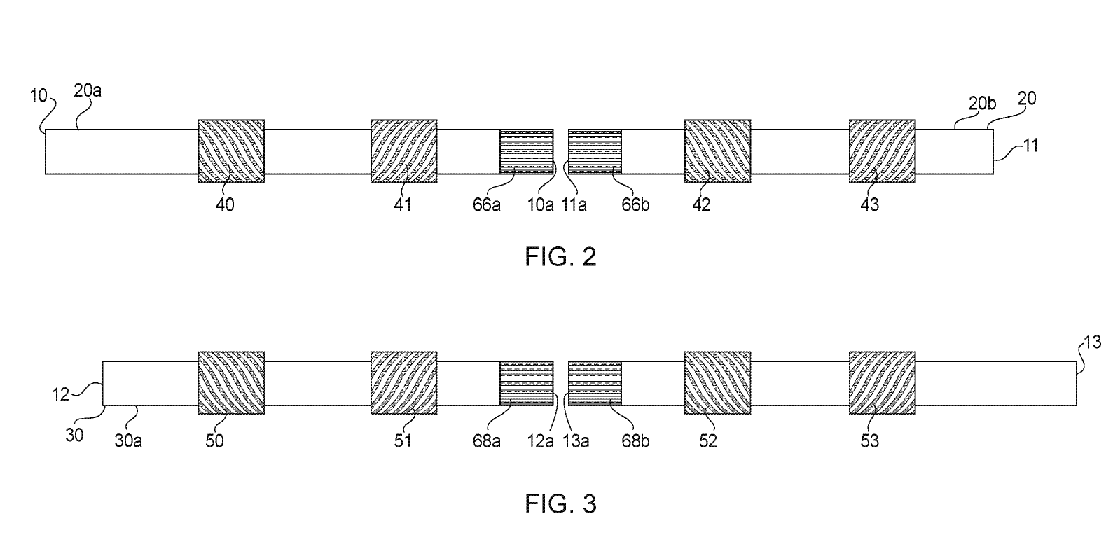

With reference to FIGS. 1, 4, 5 and 6, there is provided a spline helical cut drive shaft 20. Spline helical cut drive shaft 20 comprises two parts 20a and 20b, as shown in FIG. 2. Spline helical cut drive shaft part 20a has a first end 10 and a second end 10a. End 10 is adapted for connection with a drive mechanism (not illustrated) for rotation of the drive shaft 20. End 10a is equipped with a straight cut spline 66a on the outer surface or diameter of the shaft. Spline helical cut drive shaft part 20b has a first end 11a and a second end 11. First end 11a is equipped with a straight cut spline 66b on the outer surface or diameter of the shaft. Spline helical cut drive shaft parts 20a and 20b are joined torsionally by spline sleeve 67. Spline sleeve 67 is a cylindrical sleeve equipped with a straight cut spline on the inner surface that mates with the straight cut splines 66a and 66b. The two spline helical cut drive shaft parts 20a and 20b, joined by spline sleeve 67, act in rotation as a single piece drive shaft, and are commonly referred to herein as spline helical cut drive shaft 20 having a first end 10 and a second end 11. Located parallel to spline helical cut drive shaft 20 is spline helical cut driven shaft 30. Spline helical cut driven shaft 30 comprises of two parts 30a and 30b, as shown in FIG. 3. Spline helical cut driven shaft part 30a has a first end 12 and a second end 12a. End 12a is equipped with a straight cut spline 68a on the outer surface of the shaft. Spline helical cut driven shaft part 30b has a first end 13a and a second end 13. End 13 is adapted for connection with an output mechanism (not illustrated) for receiving output rotation and power. First end 13a is equipped with a straight cut spline 68b on the outer surface of the shaft. Spline helical cut driven shaft parts 30a and 30b are joined torsionally by spline sleeve 69. Spline sleeve 69 is a cylindrical sleeve equipped with a straight cut spline on the inner surface that mates with the straight cut splines 68a and 68b. The two spline helical cut driven shaft parts 30a and 30b, joined by spline sleeve 69, act in rotation as a single piece driven shaft, and are commonly referred to herein as spline helical cut driven shaft 30 having a first end 12 and a second end 13.

Spline helical cut drive shaft 20 is split into two parts 20a and 20b, for the purpose of assembly of the drive wheel train. That is, since the helical cut splines 40 and 41 on drive shaft part 20a are of opposite sense or hand, one cannot install drive wheels 21a and 21b having a helical cut spline on the inner diameter from the same end. Drive wheel 21a must be installed from end 10 of drive shaft part 20a and drive wheel 21b must be installed from end 10a. Likewise, drive wheel 22a must be installed on drive shaft part 20b from end 11a and drive wheel 22b must be installed from end 11. A like situation exists for driven shaft 30, where the shaft must be split into two shaft parts 30a and 30b for assembly purposes. It is appreciate by one skilled in the art that if additional pairs of drive wheels and corresponding driven wheels are needed, those additional drive wheels/driven wheels would be mounted on additional shaft parts joined by spline sleeves to the existing shaft parts, again to allow assembly of the additional pairs of drive wheels/driven wheels, for the same reason as described above.

In the drawing figures, like part numbers correspond to like parts.

Mounted on spline helical cut drive shaft 20 for rotation by the drive shaft are a first pair of drive wheels 25 comprising first drive wheel half 21a and second drive wheel half 21b. Also mounted on spline helical cut drive shaft 20 for rotation by the drive shaft are a second pair of wheel drive wheels 26 comprising first drive wheel half 22a and second drive wheel half 22b. The first and second pairs of drive wheels 25, 26 are also mounted on spline helical cut drive shaft 20 for axial movement on spline helical cut drive shaft 20 in the axial direction of spline helical cut drive shaft 20. In accordance with the present invention, more than two pairs of drive wheels could be mounted on spline helical cut drive shaft 20 for rotation by the drive shaft or one pair of drive wheels could be mounted on spline helical cut drive shaft 20 for rotation by the drive shaft.

Mounted on spline helical cut driven shaft 30 for rotating the driven shaft are a first pair of driven wheels 35 comprising a first driven wheel half 31a and a second driven wheel half 31b. Also mounted on spline helical cut driven shaft 30 for rotating the driven shaft are a second pair of driven wheels 36 comprising a first driven wheel half 32a and a second driven wheel half 32b. The first and second pairs of driven wheels 35, 36 are also mounted on spline helical cut driven shaft 30 for axial movement on spline helical cut driven shaft 30 in the axial direction of spline helical cut driven shaft 30. In accordance with the present invention, more than two pairs of driven wheels could be mounted on spline helical cut driven shaft 30 for rotating spline helical cut driven shaft 30 or one pair of driven wheels could be mounted on spline helical cut driven shaft 30 for rotating the driven shaft.

Pair of drive wheels 25 corresponding to pair of driven wheels 35 forms a first set of drive wheels/driven wheels. Pair of drive wheels 26 corresponding to pair of driven wheels 36 forms a second set of drive wheels/driven wheels. Thus, a set of drive wheels/driven wheels comprises a pair of drive wheels mounted on the spline helical cut drive shaft corresponding to a pair of driven wheels mounted on the spline helical cut driven shaft. It will be understood that the illustration of two sets of paired drive wheels/driven wheels in the embodiment of FIGS. 1, 4, 5 and 6 of the drawings is by way of illustrative example and not by way of limitation. The actual number of sets of paired drive wheels/driven wheels employed by one skilled in the art would be determined by the design requirements of the intended application. There could be one set of paired drive wheels/driven wheels or a plurality of sets of paired drive wheels/driven wheels in accordance with the present invention.

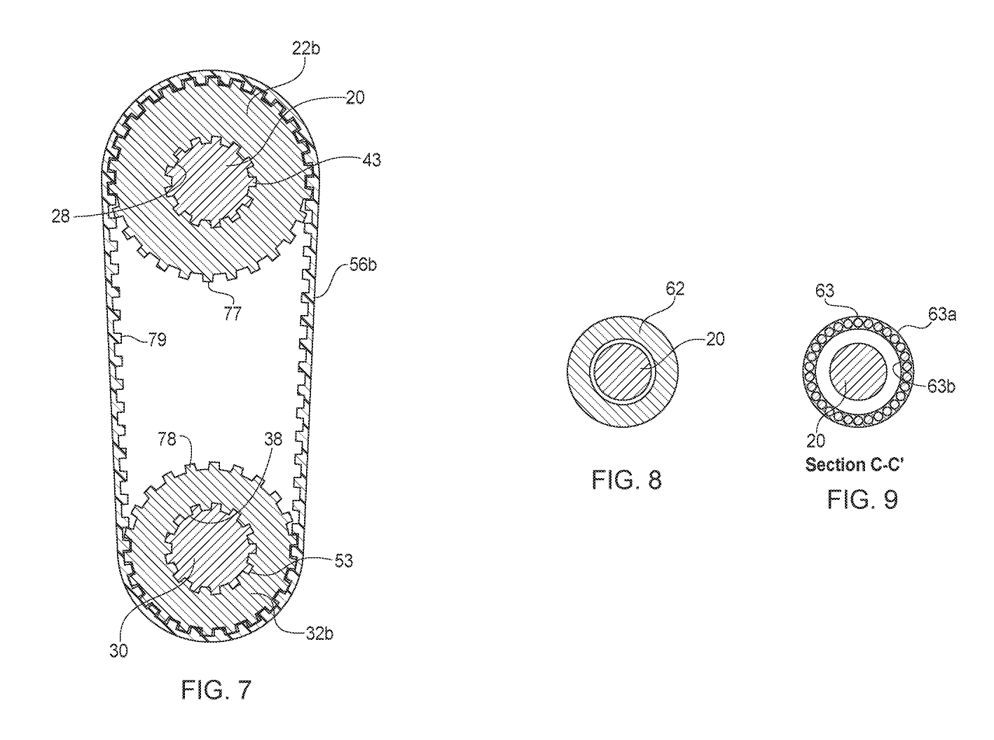

In the present invention, each drive wheel half and each driven wheel half is a cylindrical type member. See FIG. 7 schematically illustrating drive wheel half 22b and driven wheel half 32b. In accordance with the present invention, the inner diameter of each cylindrical type member drive wheel/driven wheel is provided with a helical cut spline. See FIG. 7 schematically illustrating helical cut spline 28 on the inner diameter of drive wheel half 22b and helical cut spline 38 on the inner diameter of driven wheel half 32b. FIG. 7 schematically illustrates helical cut spline 43 on spline helical cut drive shaft 20. Helical cut spline 28 on the inner diameter of drive wheel half 22b engages helical cut spline 43 on spline helical cut drive shaft 20. FIG. 7 schematically illustrates helical cut spline 53 on spline helical cut driven shaft 30. Helical cut spline 38 on the inner diameter of driven wheel half 32b engages helical cut spline 53 on spline helical cut driven shaft 30.

In accordance with the present invention, the helical cut spline on the inner diameter of each drive wheel half and each driven wheel half engages the helical cut spline on the outer diameter of the drive or driven shaft.

FIG. 2 illustrates helical cuts splines 40, 41, 42, 43 on the outer diameter of spline helical cut drive shaft 20. FIG. 3 illustrates helical cuts splines 50, 51, 52, 53 on the outer diameter of spline helical cut driven shaft 30. See also FIG. 1 wherein drive wheel halves 21a, 21b, 22a, 22b have been partially cut away to illustrate the helical cuts splines 40, 41, 42, 43 on spline helical cut drive shaft 20 and driven wheel halves 31a, 31b, 32a, 32b have been partially cut away to illustrate the helical cuts splines 50, 51, 52, 53 on spline helical cut driven shaft 30.

In one embodiment of the present invention, with reference to drive wheel pair 25, 35, drive wheel pair 25 comprising drive wheel half 21a and drive wheel half 21b, each have a helical cut spline on the inner diameter at the same angle but in the opposite sense or hand to one another. The inner diameter helical cut spline of drive wheel half 21a engages helical cut spline 40 on the outer diameter of spline helical cut drive shaft 20. The inner diameter helical cut spline of drive wheel half 21b engages helical cut spline 41 on the outer diameter of spline helical cut drive shaft 20. In this embodiment of the present invention, helical cut spline 40 and helical cut spline 41 on the outer diameter of spline helical cut drive shaft 20 would have the same angle but in the opposite sense or hand to one another.

In this embodiment of the present invention, the angle of the inner diameter helical cut spline of drive wheel half 21a would be the same as the angle of the helical cut spline 40 on the outer diameter of spline helical cut drive shaft 20. The angle of the inner diameter helical cut spline of drive wheel half 21b would be the same angle as the angle of the helical cut spline 41 on the outer diameter of spline helical cut drive shaft 20.

Counter-clockwise rotation of spline helical cut drive shaft 20 will result in an axial thrust on drive wheel half 21a and drive wheel half 21b of drive wheel pair 25 of the first set of drive wheel/driven wheels to be directed inward pushing drive wheel half 21a and drive wheel half 21b toward one another tightly together in the axial direction of spline helical cut drive shaft 20. It will be appreciated by one skilled in the art that the inner diameter helical cut spline on drive wheel half 21a and drive wheel half 21b will enable drive wheel half 21a to move in the axial direction on helical cut spline 40 on the outer diameter of spline helical cut drive shaft 20 and will enable drive wheel half 21b to move in the axial direction on helical cut spline 41 on the outer diameter of spline helical cut drive shaft 20.

With further reference to driven wheel pair 35, driven wheel pair 35 comprising driven wheel half 31a and driven wheel half 31b, each have a helical cut spline on the inner diameter at the same angle but in the opposite sense or hand to one another. The inner diameter helical cut spline of driven wheel half 31a engages helical cut spline 50 on the outer diameter of spline helical cut driven shaft 30. The inner diameter helical cut spline on driven wheel half 31b engages helical cut spline 51 on the outer diameter of spline helical cut driven shaft 30. In this embodiment of the present invention, helical cut spline 50 and helical cut spline 51 on the outer diameter of spline helical cut driven shaft 30 would have the same angle but in the opposite sense or hand to one another.

In this embodiment of the present invention, the angle of the inner diameter helical cut spline of driven wheel half 31a would be the same angle as the angle of the helical cut spline 50 on the outer diameter of spline helical cut driven shaft 30. The angle of the inner diameter helical cut spline of driven wheel half 31b would be the same as the angle of the helical cut spline 51 on the outer diameter of spline helical cut driven shaft 30.

In this embodiment of the present invention, the angle of the inner diameter helical cut spline of drive wheel half 21a is the same as the angle of the inner diameter helical cut spline on driven wheel half 31a, but of opposite sense or hand. The angle of the inner diameter helical cut spline of drive wheel half 21b is the same as the angle of the inner diameter helical cut spline on driven wheel half 31b, but of opposite sense or hand.

Counter-clockwise rotation of spline helical cut drive shaft 20 and thus counter-clockwise rotation of drive wheel half 21a and drive wheel half 21b will cause counter-clockwise rotation of closed loop toothed belt 55a and closed loop toothed belt 55b and thus counter-clockwise rotation of driven wheel half 31a and driven wheel half 31b such that driven wheel half 31a and driven wheel half 31b separate with respect to one another in the axial direction of spline helical cut driven shaft 30. It will be appreciated by one skilled in the art that the inner diameter helical cut splines on driven wheel half 31a and driven wheel half 31b will enable driven wheel half 31a to move in the axial direction on helical cut spline 50 on the outer diameter of spline helical cut driven shaft 30 and will enable driven wheel half 31b to move in the axial direction on helical cut spline 51 on the outer diameter of spline helical cut driven shaft 30.

In the described embodiment, counter-clockwise rotation of spline helical cut drive shaft 20 will eventually cause counter-clockwise rotation of spline helical cut driven shaft 30.

In accordance with another embodiment of the present invention (not illustrated), spline helical cut drive shaft 20 could be rotated in the clockwise direction establishing axial thrusts which cause drive wheel halves 21a and 21b to separate in the axial direction of spline helical cut drive shaft 20 and driven wheel halves 31a and 31b to be pushed together in the axial direction of spline helical cut driven shaft 30. It will also be apparent to one skilled in the art that the sense or hand of the helical cuts on the inner diameter of drive wheel halves 21a, 21b and driven wheel halves 31a, 31b could be reversed or made opposite and the spline helical cuts 40, 41 on the spline helical cut drive shaft 20 and the spline helical cuts 50, 51 on the spline helical cut driven shaft 30 could be reversed or made opposite and the described principle of operation, in accordance with the present invention, would apply.

The foregoing description with respect to the first set of drive wheels/driven wheels comprising pair of drive wheels 25 and pair of driven wheels 35 applies to the second set of drive wheels/driven wheels comprising pair of drive wheels 26 and pair of driven wheels 36. One skilled in the art can employ as many sets of drive wheels/driven wheels as would be determined by the design requirements of the intended application.

With yet further reference to the drawings, it will be appreciated by one skilled in the art that the outer diameter of the drive wheels on the spline helical cut drive shaft 20 is larger than the outer diameter of the driven wheels on the spline helical cut driven shaft 30. Thus, the embodiment of the present invention illustrated in the drawings is a step up belt/chain drive system. It will be further appreciated by one skilled in the art that the outer diameter of the drive wheels on the spline helical cut drive shaft 20 could be smaller than the outer diameter of the driven wheels on the spline helical cut driven shaft 30, with this embodiment of the present invention (not illustrated) being a step down belt/chain drive system. As illustrated, the outer diameter of all drive wheels on the spline helical cut drive shaft is the same and the outer diameter of all driven wheels on the spline helical cut driven shaft is the same.

The helical cut splines could be provided on the outer diameter of the spline helical cut drive shaft and spline helical cut driven shaft when the drive shaft/driven shaft are being machined. One skilled in the art could devise other ways to provide the helical cut splines on the outer diameter of the spline helical cut drive shaft and spline helical cut driven shaft. The helical cut spline on the inner diameter of the cylindrical type member drive wheels/driven wheels could be provided when the drive wheels/driven wheels are machined. One skilled in the art could devise other ways to provide the helical cut spline on the inner diameter of the cylindrical type member drive wheels/driven wheels.

With reference to FIGS. 1, 4, 5 and 6, in one embodiment of the present invention, a closed loop toothed belt 55a engages the outer diameter of drive wheel half 21a and driven wheel half 31a. Likewise, a closed loop toothed belt 55b engages the outer diameter of drive wheel half 22b and the outer diameter driven wheel half 31b. A closed loop toothed belt 56a engages the outer diameter of drive wheel half 22a and the outer diameter of driven wheel half 32a. A closed loop toothed belt 56b engages the outer diameter of drive wheel half 22b and the outer diameter of driven wheel half 32b. In this embodiment of the present invention, when spline helical cut shaft 20 is rotated in the counter-clockwise direction and thus drive wheel halves 21a, 21b, 22a, 22b are rotated in the counter-clockwise direction, this results in closed loop toothed belts 55a, 55b, 56a, 56b rotating in the counter-clockwise direction, this rotating driven wheel halves 31a, 31b, 32a, 32b in the counter-clockwise direction, which causes spline helical cut driven shaft 30 to rotate in the counter-clockwise direction. Closed loop toothed belts 55a, 55b, 56a, 56b are all essentially parallel to one another. If more than two sets of drive wheels/driven wheels are provided in a selected design (not illustrated), a closed loop toothed belt would be provided engaging each corresponding drive wheel and driven wheel.

In the embodiment of the present invention schematically illustrated in FIG. 7, drive wheel half 22b has teeth 77 on the outer diameter of drive wheel half 22b and driven wheel half 32b has teeth 78 on the outer diameter of driven wheel half 32b. Closed loop toothed belt 56b has teeth 79 on the interior surface of closed loop toothed belt 56b. In operation, teeth 79 on the interior surface of closed loop toothed belt 56b engage teeth 77 on the outer diameter of drive wheel half 22b and teeth 78 on the outer diameter of driven wheel half 32b for transmitting rotational power and torque from drive wheel half 22b to driven wheel half 32b. Similarly, drive wheel halves 21a, 21b and 22a have teeth 77 on the outer diameter thereof and driven wheel halves 31a, 31b and 32a have teeth 78 on the outer diameter thereof. Closed loop toothed belts 55a, 55b and 56a similarly have teeth 79 on the interior surface thereof. Therefore, similarly, drive wheel halves 21a, 21b and 22a transmit rotational power and torque via engaging toothed belts 55a, 55b and 56a to driven wheel halves 31a, 31b and 32a.

With reference to FIGS. 1, 4, 5 and 6 of the drawings, drive wheel halves 21a, 21b, 22a and 22b each have a cylindrical flange bearing member 62 mounted on their outer face facing first end 10 of spline helical cut drive shaft 20. Drive wheel halves 21a, 21b, 22a and 22b each also have a cylindrical flange bearing member 62 mounted on their outer face facing second end 11 of spline helical cut drive shaft 20. Driven wheel halves 31a, 31b, 32a, 32b each have a cylindrical flange bearing member 62 mounted on their outer face facing first end 12 of spline helical cut driven shaft 30. Driven wheel halves 31a, 31b, 32a and 32b each have a cylindrical flange bearing member 62 mounted on their outer face facing second end 13 of spline helical cut driven shaft 30. The cylindrical flange bearing members 62 move axially with respect to the spline helical cut drive shaft 20 and the spline helical cut driven shaft 30 along with their respective drive/driven wheel half. Cylindrical flange bearing members 62 are schematically illustrated in cross-section, with parts omitted, in FIG. 8 of the drawings.

The axial length of each cylindrical flange bearing member 62 would be selected based upon load bearing requirements of the belt/chain drive system. However, at a minimum, the length of member 62 would be chosen to be sufficient to maintain the inner diameter helical cut spline on the respective drive wheel halves 21a, 21b, 22a, 22b in full engagement with the respective helical cut splines 40, 41, 42, 43 on the outer diameter of spline helical cut drive shaft 20. Likewise, the axial length of each cylindrical flange bearing member 62 for the driven wheel halves would be chosen from load bearing considerations, however, at a minimum would be chosen to maintain the inner diameter helical cut spline on the respective driven wheel halves 31a, 31b, 32a, 32b in full engagement with the respective helical cut splines 50, 51, 52, 53 on the outer diameter of spline helical cut driven shaft 30.

It will be appreciated that one skilled in the art could provide bearing housings for supporting cylindrical flange being members 62 and for maintaining the alignment of spline helical cut drive shaft 20 and spline helical cut driven shaft 30.

With reference to the embodiment of the present invention illustrated in FIGS. 1, 4, 5 and 6, a retaining ring 57a is located near first end 10 of spline helical cut drive shaft 20 and a retaining ring 57b is located near second end 11 of spline helical cut drive shaft 20. A retaining ring 58a is located near first end 12 of spline helical cut driven shaft 30 and a retaining ring 58b is located near the second end 13 of spline helical cut driven shaft 30. The retaining rings 57a, 57b, 58a, 58b are mounted on their respective shafts so that they cannot move in the axial direction of their respective shafts. Retaining rings 57a, 57b on spline helical cut drive shaft 20 retain or stop axial movement of drive wheel halves on the spline helical cut drive shaft 20. Retaining rings 58a, 58b on spline helical cut driven shaft 30 retain or stop axial movement of driven wheel halves on spline helical cut driven shaft 30. The function of the retaining rings will be hereinafter more fully explained.

Spline helical cut drive shaft 20 and spline helical cut driven shaft 30 are mounted (not illustrated) so that they remain parallel to one another and so that they do not move in their respective axial directions in response to forces established by rotation of the respective shafts and rotation of respective drive wheel halves and driven wheel halves.

With reference to the embodiment of the present invention illustrated in FIGS. 1, 4, 5 and 6, a thrust bearing 63 is mounted on spline helical cut drive shaft 20 between drive wheel half 21a and drive wheel half 21b. A thrust bearing 64 is mounted on spline helical cut drive shaft 20 between drive wheel half 22a and drive wheel half 22b. A thrust bearing 65a is mounted on spline helical cut driven shaft part 30a between driven wheel half 31b and spline sleeve 69. A thrust bearing 65b is mounted on spline helical cut driven shaft part 30b between driven wheel half 32a and spline sleeve 69. Thrust bearings 63, 64 are mounted on spline helical cut drive shaft 20 for axial movement with respect to spline helical cut drive shaft 20. Thrust bearings 65a and 65b are mounted on spline helical cut driven shaft 30 for axial movement with respect to spline helical cut driven shaft 30. FIG. 9 schematically illustrates in cross-section, with parts removed, a ball bearing type thrust bearing 63 comprising bearing race 63a and ball bearings 63b. A thrust bearing could be a washer.

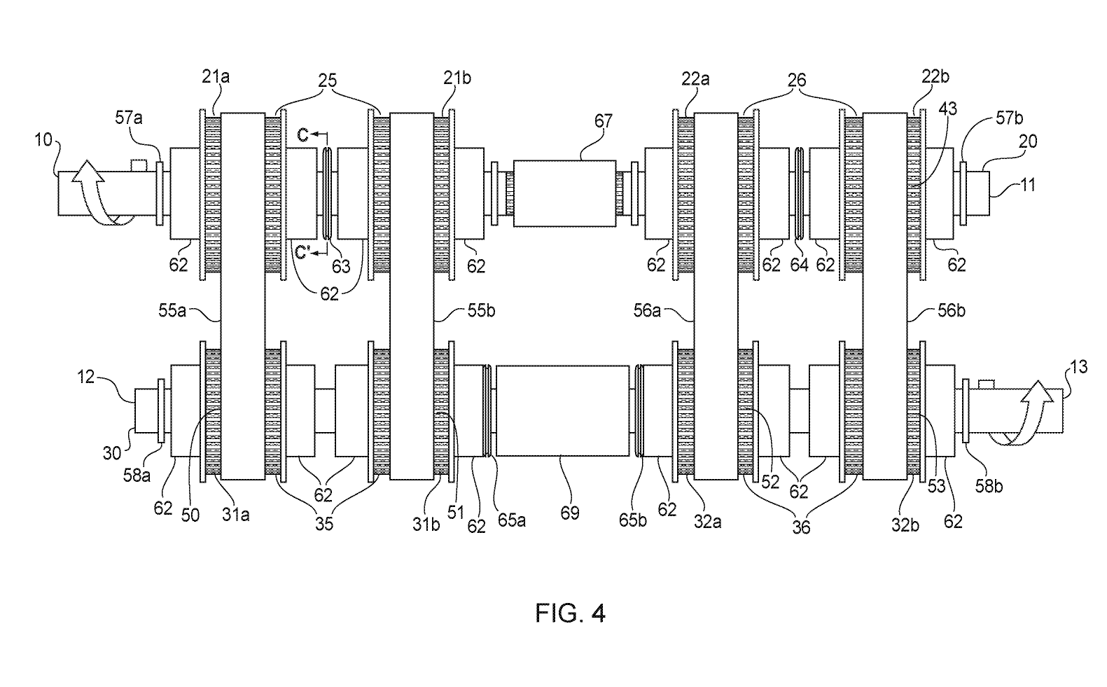

Operation of the belt/chain drive system, in accordance with the present invention, will now be explained in conjunction with FIGS. 4, 5 and 6. FIG. 4 schematically illustrates an embodiment of the present invention, which uses two sets of drive wheels/driven wheels, prior to the start of rotation of spline helical cut drive shaft 20. The first set of drive wheels/driven wheels comprises a pair of drive wheel halves 25 engaging via toothed belts 55a, 55b a pair of driven wheel halves 35. The second set of drive wheels/driven wheels comprises a pair of drive wheel halves 26 engaging via toothed belts 56a, 56b a pair of driven wheel halves 36.

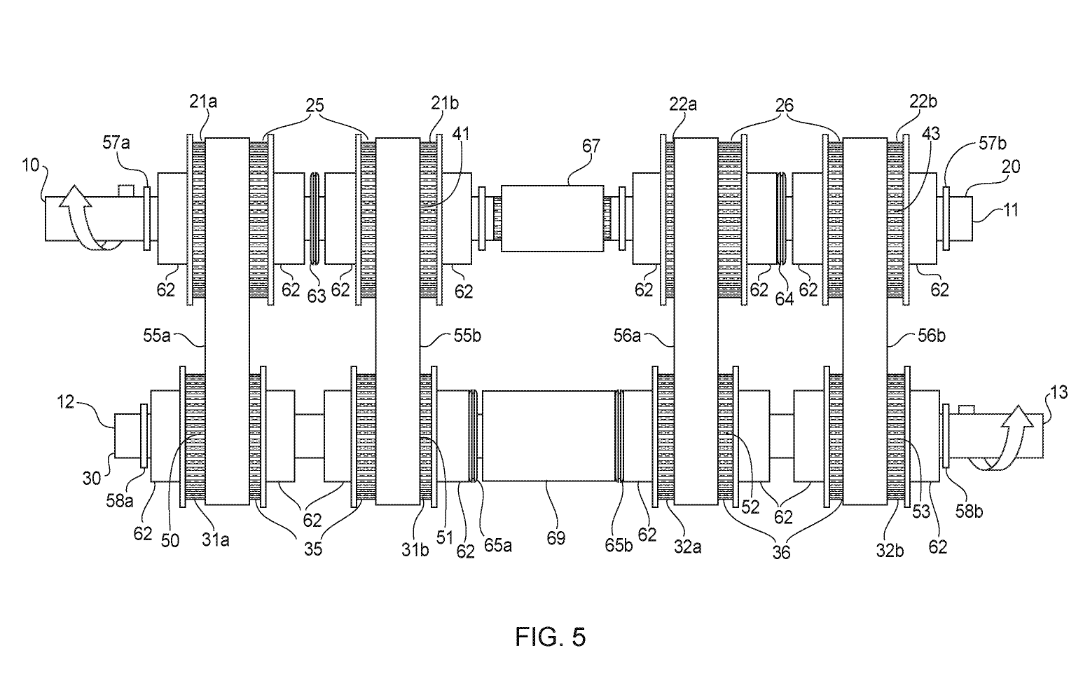

Rotation of spline helical cut drive shaft 20 is started in the counter-clockwise direction in the embodiment of the present invention schematically illustrated in FIGS. 4, 5 and 6 of the drawings. Upon the start of this counter-clockwise rotation of spline helical cut drive shaft 20, due to inherent variations and manufacturing tolerances, one set of drive wheels/driven wheels, say 26, 36, will engage first via closed loop toothed belts 56a, 56b. The axial thrust previously explained will cause driven wheel half 32a and driven wheel half 32b to begin to separate in the axial direction on spline helical cut driven shaft 30. Drive wheel half 22a and drive wheel half 22b will begin to be pushed together in the axial direction of spline helical cut drive shaft 20. This is schematically illustrated (greatly exaggerated) in FIG. 5. This allows spline helical cut drive shaft 20 to further rotate in the counter-clockwise direction without loading or rotating the driven wheel halves 32a, 32b via closed loop toothed belts 56a, 56b.

Due to inherent variations and manufacturing tolerances and continued counter-clockwise rotation of spline helical cut drive shaft 20, the second set of drive wheels/driven wheels 25, 35 will begin to engage via closed loop toothed belts 55a, 55b and driven wheel half 31a and driven wheel half 31b will begin to separate in the axial direction on spline helical cut driven shaft 30 due to axial thrusts. Drive wheel half 21a and drive wheel half 21b will begin to be pushed together in the axial direction on spline helical cut drive shaft 20.

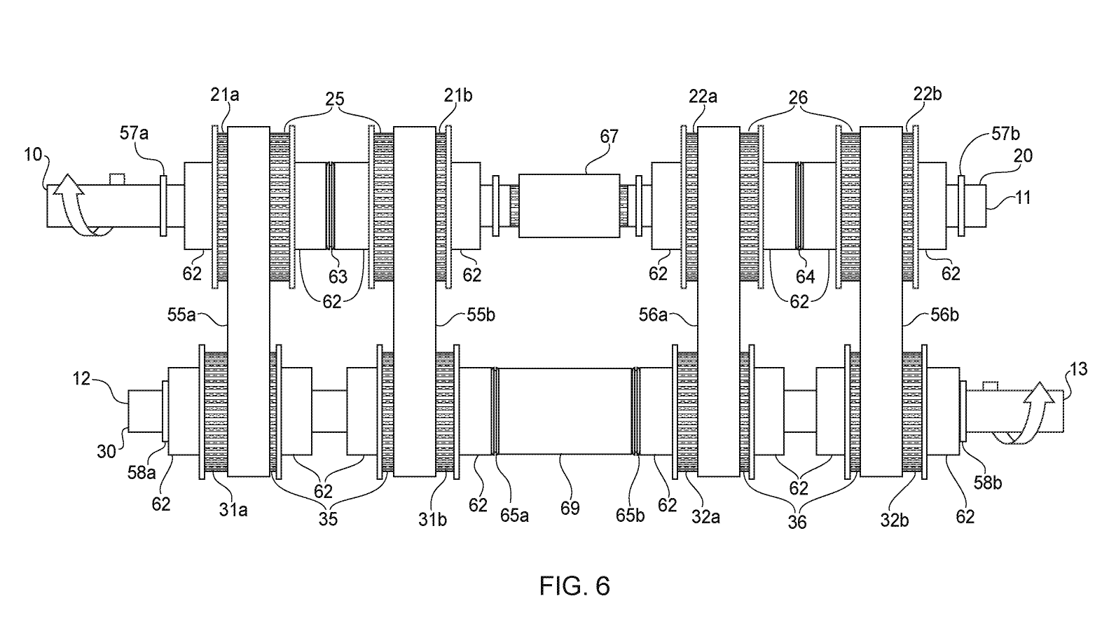

Inherent variations and manufacturing tolerances will continue to permit counter-clockwise rotation of spline helical cut drive shaft 20 without loading of the spline helical cut drive shaft 20 and without rotation of spline helical cut driven shaft 30 due to the continued spreading of the pairs of driven wheel halves until such time that retaining rings 58a, 58b on spline helical cut driven shaft 30 stop the axial spreading of the pairs of driven wheels by abutment with force of cylindrical flange bearing member 62 on driven wheel half 31a with retaining ring 58a and abutment with force of cylindrical flange bearing member 62 on driven wheel half 32b with retaining ring 58b and by cylindrical flange bearing members 62 on adjacent driven wheel half 31b and driven wheel half 32a being in abutment with force with thrust bearings 65a, 65b on spline helical cut driven shaft 30. This is illustrated in FIG. 6.

FIG. 6 also illustrates cylindrical flange bearing members 62 of adjacent drive wheel half 21a and drive wheel half 21b abutting with force thrust bearing 63 on spline helical cut drive shaft 20 and likewise cylindrical flange bearing members 62 of adjacent drive wheel half 22a and drive wheel half 22b abutting with force thrust bearing 64 on spline helical cut drive shaft 20.

The function of thrust bearings 63 and 64 is as follows. Under loading, adjacent drive wheel half 21a and drive wheel 21b push towards one another with significant force. Likewise adjacent drive wheel half 22a and drive wheel half 22b push towards one another with significant force. For load balancing to occur the drive wheel pair 21a and 21b must be able to move, as a pair, axially on drive shaft 20 to center with respect to closed loop toothed belts 55a, 55b. Since the drive wheels 22a and 21b are mounted, on shaft 20 via helical splines of opposite hand or sense, as the drive wheel pair 21a and 21b move axially along shaft 20, drive wheel 21a will rotate in the opposite direction as drive wheel 21b. Thrust bearing 63 allows the drive wheel pair 21a and 21b, which are forcefully pushing together, to rotate relative to one another. If there were no accommodation for this relative rotation, the drive wheel pair 22a and 21b would act as a single wheel, and would be unable to move axially along shaft 20, being locked in place by their opposite hand helical splines. Thrust bearing 64 functions similarly for drive wheel pair 22a and 22b.

The design permits spline helical drive shaft 20 to continue to rotate in the counter-clockwise direction in the unloaded condition until all sets of drive wheels/driven wheels engage via closed loop toothed belts and spreading of all pairs of driven wheel halves starts in the axial direction of spline helical cut driven shaft 30 without loading and rotation of the spline helical cut driven shaft 30. That is, retaining rings 58a and 58b are located on spline helical cut driven shaft 30 to provide sufficient axial play or axial distance so that all pairs of driven wheel halves of all drive wheel/driven wheel sets have begun to separate in the axial direction of spline helical driven shaft 30 prior to cylindrical flange bearing member 62 of outermost driven wheel half 31a being abutted with force against retaining ring 58a and cylindrical flange bearing member 62 of outermost driven wheel half 32b being abutted with force against retaining ring 58b. With this continued rotation of drive shaft 20, driven wheels 31b and 32a are pushed toward one another. Between driven wheels 31b and 32a is spline sleeve 69, and bearing members 62 of driven wheels 31b and 32a abut spline sleeve 69, as driven wheels 31b and 32a forcibly push towards one another. Between bearing member 62 of driven wheel 31b and spline sleeve 69 is a thrust bearing 65a. Between bearing member 62 of driven wheel 32a and spline sleeve 69 is a thrust bearing 65b. Thrust bearings 65a and 65b allow the relative rotation between driven wheels 31b and 32a to allow axial movement of the driven wheels 31b and 32a necessary for load sharing. Spline sleeve 69 provides the compressional connection between driven wheels 31b and 32a. At the time retaining rings 58a and 58b prevent any further total axial spreading of the pairs of driven wheel pairs, loading of the spline helical cut drive shaft 20 and rotation of spline helical cut driven shaft 30 begin. The distance of the axial spreading between driven wheel halves of the pairs of driven wheel halves can still change relative to one another to balance load which will hereinafter be discussed.

FIG. 6 illustrates the spreading of all pairs of driven wheel halves in the axial direction of spline helical cut driven shaft 30 with axial spreading being stopped by retaining rings 58a and 58b.

The unloaded counter-clockwise rotation of spline helical drive shaft 20 continues until all the play or axial movement of driven wheel halves of the pairs of driven wheel halves permitted by the positioning of the retaining rings 58a, 58b on spline helical driven shaft 30 is taken up. When the driven wheel halves on the spline helical driven shaft 30 are bearing with force against one another and against the retaining rings, all driven wheel halves are engaged and loaded via closed loop toothed belts as hereinafter discussed and rotation of the spline helical cut driven shaft begins.

Since the thrust causing axial spreading of the pairs of driven wheel halves is directly proportional to the load carried by each pair, any imbalance in load results in a thrust imbalance between the pairs of drive wheel halves. That is, the pair of driven wheel halves which is experiencing the heavier load will start to spread further. Since the retaining rings will not allow any additional total axial spreading of the pairs of driven wheel halves on the spline helical cut driven shaft, the spreading of the heavier loaded pair of driven wheel halves cause other pairs of driven wheel halves on the spline helical cut driven shaft to be pushed toward one another reducing their axial separation, which increases their load share and thereby rebalances the load. Since all the driven wheel halves of pairs of driven wheel halves on the spline helical cut driven shaft are allowed to move freely and interact with one another, there is a net thrust from only the driven wheel half at each end of the spline helical cut driven shaft. The thrust of the other driven wheel halves is balanced by the opposite thrust of adjacent driven wheel halves.

Just as the driven wheel halves must be free to move axially on the spline helical cut driven shaft, the drive wheel halves must be free to move axially on the spline helical cut drive shaft.

As previously discussed, the counter-clockwise rotation of spline helical cut drive shaft 20 in the illustrated embodiment results in pairs of drive wheels 21a, 21b and 22a, 22b to be pushed tightly together in the axial direction of spline helical cut drive shaft 20. However, the pairs of drive wheels pushed tightly together must be free to move axially on the spline helical cut drive shaft 20. Due to inherent variations and differences in manufacturing tolerances, the pairs of driven wheel halves on the spline helical cut driven shaft do not spread equally in the axial direction of the spline helical cut driven shaft. This uneven spreading of the pairs of driven wheel halves results in an unbalanced load on one side or the other of the pairs of drive wheel halves which causes the pairs of drive wheel halves pushed tightly together to move axially along the spline helical cut drive shaft to “center” themselves with respect to respective closed loop toothed belts and with respect to respective pairs of driven wheels to achieve balanced load.

The foregoing described interaction between the pairs of drive wheel halves on the spline helical cut drive shaft and the pairs of driven wheel halves on the spline helical cut driven shaft results in automatic balancing of load between all pairs of drive wheel halves and driven wheel halves engaging via closed looped toothed belts.

In the embodiment described, retaining rings 58a, 58b fixed on spline helical cut driven shaft 30 must permit for sufficient play or axial movement of the pairs of driven wheel halves on spline helical cut driven shaft 30 so that all pairs of driven wheel halves mounted on spline helical cut driven shaft 30 spread prior to retaining rings 58a, 58b preventing additional total axial spreading of the pairs of driven wheel halves on spline helical cut driven shaft 30 and thus load being transmitted from spline helical cut drive shaft 20 via engaging closed loop toothed belts to spline helical cut driven shaft 30.

This distance of the axial spreading of the pairs of driven wheel halves illustrated in FIGS. 5 and 6 is greatly exaggerated for purposes of description of the present invention. In actual practice, the axial spreading of the pairs of driven wheel halves on the spline helical cut driven shaft of the illustrated embodiment will be on the order of a few thousandths of an inch or on the order of a thousandth of a millimeter.

As previously discussed, the width of the toothed portion of the toothed drive/driven wheels is greater than the width of the closed loop toothed belt. This allows the closed looped toothed belt to slide axially on the toothed drive/driven wheels thereby allowing the required small relative axial movement between the drive and driven wheels on their respective shafts without causing misalignment of the closed loop toothed belt. In an embodiment of the present invention using a closed loop chain (not illustrated), the chain can be axially fixed by the teeth on the drive and driven wheels. The closed loop chains have sufficient flexibility in the axial direction to accommodate the small relative axial movement of the drive and driven wheels on their respective shafts required for even load sharing.

It will be understood that the embodiment of the present invention described in conjunction with FIGS. 4, 5 and 6 is only by way of illustrative example to explain the principles of the present invention. Many other embodiments will become readily apparent to one skilled in the art. As previously discussed, the embodiment of the present invention illustrated in FIGS. 4, 5 and 6 uses two sets of pairs of drive wheel and pairs of driven wheels. The number of sets of pairs of drive wheels and pairs of driven wheels would be dependent on upon the design criteria for a specific application. The diameters of the drive wheels and driven wheels on the spline helical cut drive shaft and spline helical cut driven shaft may be selected to provide either a step up or step down belt/chain drive system. The spline helical cut drive shaft 20 in the embodiment of FIGS. 4, 5 and 6 may be rotated in the clockwise direction. This would cause the pairs of drive wheel halves on spline helical cut drive shaft 20 to separate and the pairs of driven wheel halves on spline helical cut driven shaft 30 to be pushed together. The principles of operation of the present invention would be the same as previously described. The sense or hand of the helical cut on the spline helical cut on the spline helical cut drive shaft and the spline helical cut driven shaft could be reversed with the sense or hand of the helical cut on the inner diameter of respective drive wheel halves and driven wheel halves reversed. As will be apparent to one skilled in the art, this will not change the principles of operation of the present invention. As previously discussed, the toothed belts of the embodiment of the present invention schematically illustrated in FIGS. 1 and 4 to 6 could be chains, bands or similar devices. Again, this will not change the principle of operation of the present invention. Likewise, one skilled in the art could provide devices other than teeth on the interior surface of a closed loop belt type device and the outer diameter of the drive wheels and driven wheels for providing for engagement of the closed loop belt type device with the outer diameter of the drive wheels and driven wheels for transmission of power and torque. Again, this will not change the principle of operation of the present invention.

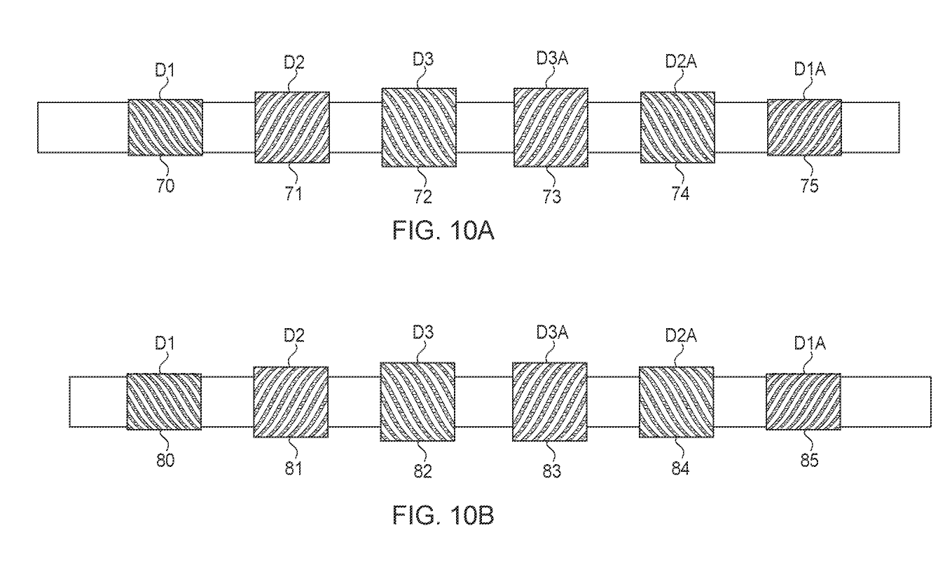

The preferred embodiment of the present invention is shown in FIGS. 1 thru 6, wherein the drive shaft 20 and driven shaft 30 comprises of multiple, shorter shafts joined by spline sleeves for the purpose of assembly. FIG. 10A illustrates an alternative embodiment of the present invention not requiring splitting the drive and the driven shafts for assembly purposes. FIG. 10A shows a one piece spline helical cut drive shaft 20 which has six spline helical cuts 70, 71, 72, 73, 74, 75 on the outer diameter of spline helical cut drive shaft 20. In the embodiment of FIG. 10A, three pairs of drive wheel halves would be used. FIG. 10B illustrates the alternative embodiment of the present invention of FIG. 10A wherein spline helical cut driven shaft 30 has six spline helical cuts 80, 81, 82, 83, 84, 85 on the outer diameter of spline helical cut driven shaft 30. Thus, in the embodiment of FIG. 10B, three pairs of driven wheel halves would be used. The embodiment of the present invention of FIGS. 10A, 10B would employ three sets of drive/driven wheel pairs.

FIGS. 10A, 10B illustrate an embodiment of the present invention which also facilitates ease of assembly of the gear transmission of the present invention when more than one set of drive/driven wheel pairs is used. With reference to FIG. 10A, inner spline helical cuts 72, 73 on drive shaft 20 have an outer diameter D3 and D3A respectively, wherein D3 equals D3A. Intermediate spline helical cuts 71, 74 have an outer diameter D2 and D2A respectively, wherein D2 equals D2A. Outer spline helical cuts 70, 75 have an outer diameter D1 and D1A respectively, wherein D1 equals D1A. Outer diameter D3, D3A of spline helical cuts 72, 73 is greater than outer diameter D2, D2A of spline helical cuts 71, 74. Outer diameter D2, D2A of spline helical cuts 71, 74 is greater than outer diameter D1, D1A of spline helical cuts 70, 75. It will be appreciated that the inner diameter of the drive wheel halves with the helical cut engaging spline helical cuts 72, 73 will be greater than the inner diameter of the drive wheel halves with the helical cut engaging spline helical cuts 71, 74. The inner diameter of the drive wheel halves with the helical cut engaging spline helical cuts 71, 74 will likewise be greater than the inner diameter of the drive wheel halves with the helical cut engaging spline helical cuts 70, 75. This arrangement will facilitate the assembly of the drive wheel halves on spline helical cut drive shaft 20.

The same arrangement described with respect to the spline helical cut drive shaft 20 of FIG. 10A would apply to spline helical cut driven shaft 30 illustrated in FIG. 10B. This arrangement will facilitate the assembly of the driven wheel halves on spline helical cut driven shaft 30.

The arrangement described with respect to FIG. 10A, 10B, can be employed in a belt/chain drive system in accordance with the present invention which uses two sets, three sets (FIGS. 10A, 10B) or a plurality of sets of drive wheel/driven wheel pairs in the belt/chain drive system of the present invention.

With reference to the embodiment of the present invention illustrated in FIGS. 10A, 10B, the outer diameter of all drive wheel halves mounted on the spline helical drive shaft would be equal to one another. The outer diameter of all driven wheel halves mounted on the spline helical cut driven shaft would be equal to one another. The difference between the outer diameter of the drive wheel halves and the outer diameter of the driven wheel halves would depend on whether the belt/chain drive system was a step up or step down belt/chain drive system.

With reference to the embodiment of the present invention illustrated in FIGS. 10A, 10B, in order to provide for equal axial force or thrust between adjacent drive wheel halves and driven wheel halves having differing inner diameters with a helical cut mounted on a spline helical cut drive/driven shaft having differing outer diameters for adjacent helical cut splines, the helical angles of the two differing helical cut splines are such that the ratio of the spline pitch diameter to the tangent of the helical angle of the spline helical cut is of equal magnitude, but opposite in sign. With this arrangement of helical cut splines in the embodiment of FIGS. 10A, 10B, when two adjacent drive wheel halves or driven wheel halves are equally loaded torsionally, their axial force or thrust will be equal but opposite in direction.

In an alternative embodiment of the present invention, if there is only one set of drive/driven wheels, i.e., one pair of drive wheels and one pair of driven wheels, each driven wheel half can be mounted on the driven shaft at a spaced apart fixed location. The driven wheel halves could be, e.g., welded on the driven shaft at a spaced apart location opposite to the drive wheel halves. In this embodiment of the present invention, the driven shaft would not have to be a spline helical cut driven shaft. The drive wheel halves of the one pair of drive wheel halves would be mounted on a spline helical cut drive shaft for axial movement on the spline helical cut drive shaft toward one another and operate as previously described to achieve balanced load transmission. It will be apparent that if rotation of the spline helical cut drive shaft and spline helical cut driven shaft were reversed, the one pair of drive wheel halves could be mounted on the drive shaft at a spaced apart fixed location and the one pair of driven wheel halves could be mounted on a spline helical cut driven shaft for axial movement toward one another.

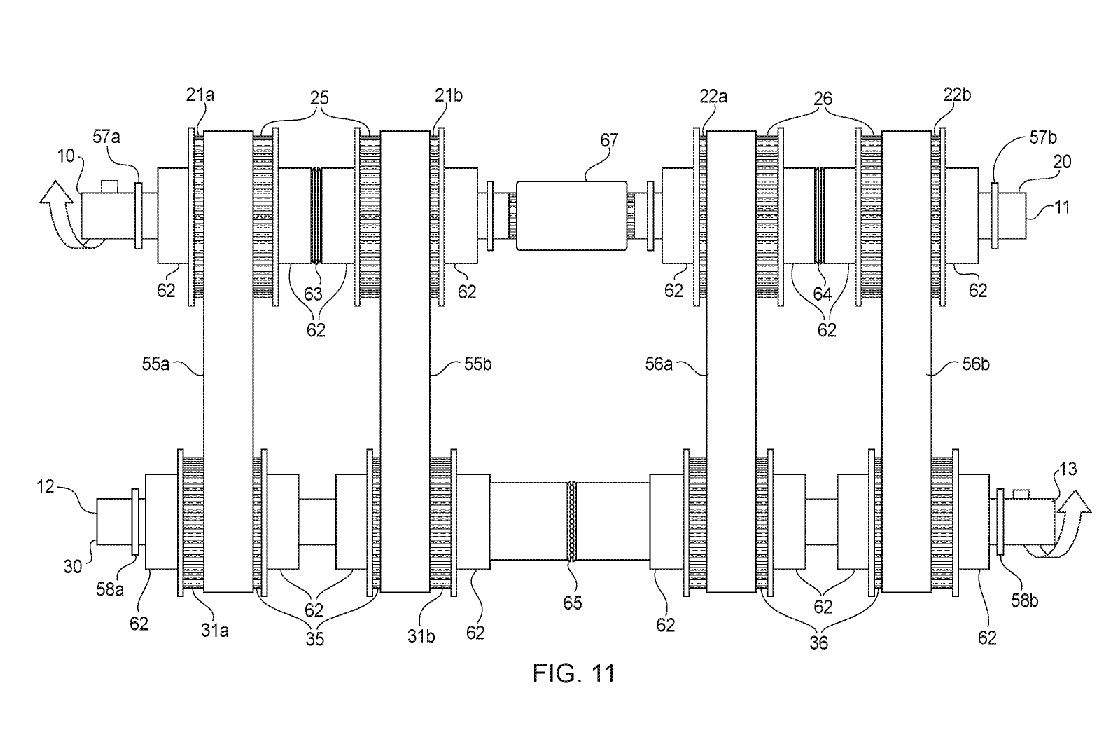

FIG. 11 schematically illustrates an alternative embodiment of the belt/chain drive system of the present invention for use with only two pair of drive wheel halves and only two pair of driven wheel halves. FIG. 11 schematically illustrates a point in time when there is equal or balanced loading among all the drive wheel halves and all the driven wheel halves wherein there is counter-clockwise rotation of spline helical cut drive shaft 20 and counter-clockwise rotation of spline helical cut driven shaft 30.

As previously discussed with respect to the embodiment of FIGS. 4 to 6, in FIG. 11, a first pair 25 of drive wheels comprising first drive wheel half 21a and second drive wheel half 21b and a second pair 26 of drive wheels comprising first drive wheel half 22a and second drive wheel half 22b are mounted on spline helical cut drive shaft 20 for rotation by drive shaft 20.

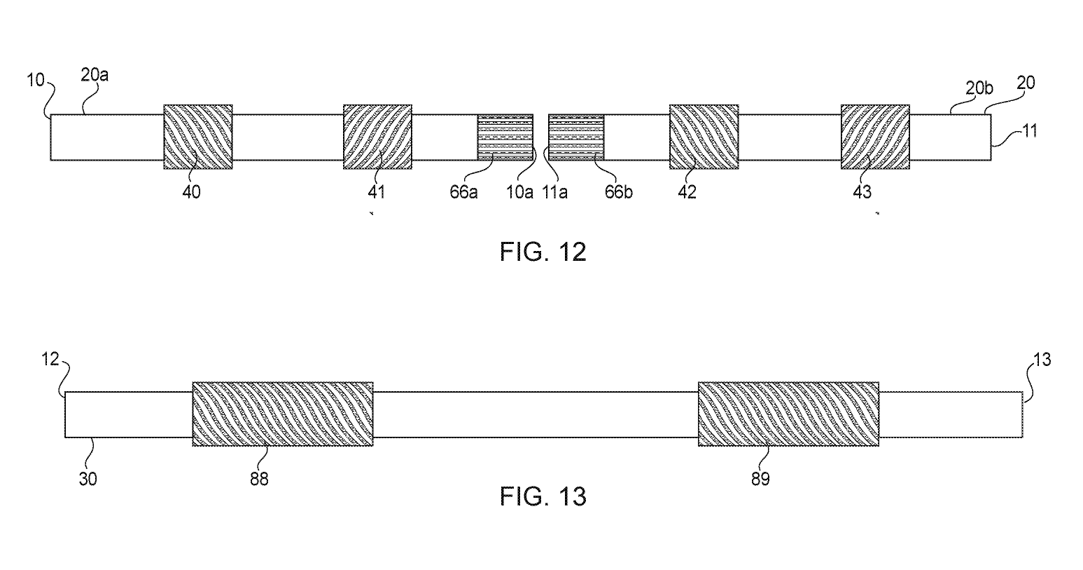

FIG. 12 schematically illustrates a preferred embodiment of a spline helical cut drive shaft 20 for use as an embodiment of a spline helical cut drive shaft 20 of the belt/chain drive system of the present invention schematically illustrated in FIG. 11. The embodiment of spline helical cut drive shaft 20 of FIG. 12 comprises spline helical cut drive shaft parts 20a and 20b joined torsionally by spline sleeve 67 to provide spline helical cut drive shaft 20 as previously discussed in detail with respect to the embodiment of the present invention schematically illustrated in FIG. 2 and FIGS. 4 to 6. As in FIG. 2, the spline helical cut drive shaft 20 of the preferred embodiment illustrated in FIG. 12 is provided with spline helical cuts 40, 41, 42, 43 on the outer diameter of spline helical cut drive shaft 20.

Upon counter-clockwise rotation of spline helical drive shaft 20 of the embodiment of FIG. 11, operation of spline helical cut drive shaft 20, first pair 25 of drive wheel halves and second pair 26 of drive wheel halves would be the same as previously described in conjunction with the embodiment of the belt/chain drive system of the present invention schematically illustrated in FIGS. 4 to 6.

Mounted on spline helical cut driven shaft 30 for rotating the driven shaft are a first pair 35 of driven wheels and a second pair 36 of driven wheels. First pair 35 of driven wheels comprises driven wheel half 31a and driven wheel half 31b. The inner diameter of driven wheel half 31a and driven wheel half 31b have a helical cut spline at the same angle and the same sense or hand. Second pair 36 of driven wheels comprises driven wheel half 32a and driven wheel half 32b. The inner diameter of driven wheel half 31a and driven wheel half 31b have a helical cut spline at the same angle and the same sense or hand. The angle and the sense or hand of the helical cut spline on the inner diameter of driven wheel halves 31a, 31b is the same angle as, but opposite in sense or hand, with respect to the helical cut spline on the inner diameter of driven wheel halves 32a, 32b.

In one embodiment of the present invention schematically illustrated in FIG. 11, first pair 35 of driven wheel halves 31a, 31b would be connected by a cylindrical sleeve 90. By way of example, driven wheel halves 31a, 31b and cylindrical sleeve 90 could be machined together. Thus, first pair 35 of driven wheel halves 31a, 31b schematically illustrated in the embodiment of the present invention of FIG. 11 would be a one-piece pair 35 of driven wheels comprising driven wheel halves 31a, 31b. Cylindrical sleeve 90 would maintain driven wheel halves 31a, 31b on spline helical cut driven shaft 30 at a fixed spaced apart axial location with respect to one another.

In one embodiment, cylindrical sleeve 90 would have a helical cut spline on an inner diameter having the same angle and the same sense or hand as the helical cut spline on the inner diameter of driven wheel halves 31a, 31b. In one-piece driven wheel pair 35 comprising driven wheel halves 31a, 31b and cylindrical sleeve 90 of FIG. 11, there is preferably a single helical cut spline on the inner diameter of driven wheel halves 31a, 31b and the inner diameter of cylindrical sleeve 90, wherein this single helical cut spline is machined when one-piece pair 35 of driven wheels is machined.

Similarly, in the embodiment of FIG. 11, there is a one-piece pair 36 of driven wheels comprising driven wheel halves 32a, 32b and cylindrical sleeve 91 having a single helical cut spline machined on the inner diameter of driven wheel halves 32a, 32b and the inner diameter of cylindrical sleeve 91. As will be appreciated, the angle of the single helical cut spline on the inner diameter of one-piece driven wheel pair 36 will be the same as the angle of the single helical cut on the inner diameter of one-piece driven wheel pair 35, but of the opposite sense or hand.

FIG. 13 schematically illustrates a spline helical cut driven shaft 30 for use in the embodiment of the present invention of FIG. 11. Spline helical cut driven shaft 30 is provided with a single first helical cut spline 88 on the outer diameter and a single second helical cut spline 89 on the outer diameter.

First helical cut spline 88 on the outer diameter of driven shaft 30 is a single helical cut spline that has the same angle and sense or hand as the single helical cut spline on the inner diameter of one-piece pair 35 of driven wheels. The helical cut spline on the inner diameter of one-piece pair 35 of driven wheels engages first helical cut spline 88 on the outer diameter of driven shaft 30. It will be appreciated, that upon rotation of spline helical cut driven shaft 30, axial thrust forces will be established causing one-piece pair 35 of driven wheel halves 31a, 31b to move axially as a unit on spline helical cut driven shaft 30.

Second helical cut spline 89 provided on the outer diameter of driven shaft 30 is a single helical cut spline that has the same angle and sense or hand as the single helical cut spline on the inner diameter of one-piece pair 36 of driven wheels. The spline helical cut on the inner diameter of one-piece pair 36 of driven wheels engages second helical cut spline 89 on the outer diameter of driven shaft 30. It will be appreciated, that upon rotation of spline helical cut driven shaft 30, axial thrust forces will be established causing one-piece pair 36 of driven wheel halves 32a, 32b to move axially as a unit on spline helical cut driven shaft 30.

The outer diameter of single first helical cut spline 88 on driven shaft 30 is the same as the outer diameter of single second helical cut spline 89 on driven shaft 30.

First pair 25 of drive wheel halves 21a, 21b engage via closed loop toothed belts 55a, 55b first one-piece pair 35 of driven wheel halves 31a, 31b. Second pair 26 of drive wheel halves 22a, 22b engage via closed loop toothed belts 56a, 56b second one-piece pair 36 of driven wheel halves 32a, 32b.

As previously discussed in detail in conjunction with FIGS. 3 to 6, counter-clockwise rotation of spline helical cut drive shaft 20 results in drive wheel half 21a and drive wheel half 21b to move toward each other on spline helical cut drive shaft 20 and push tightly together against thrust bearing 63. Similarly, drive wheel halves 22a, 22b move toward each other on spline helical cut drive shaft 20 and push tightly together against thrust bearing 64. Likewise, drive wheel halves 21a, 22b move together in the axial direction on spline helical cut drive shaft 20 and drive wheel halves 22a, 22b move together in the axial direction on spline helical cut drive shaft 20.

The counter-clockwise rotation of spline helical cut drive shaft 20 and thus drive wheel halves 21a, 21b and drive wheel halves 22a, 22b cause counter-clockwise rotation of closed loop toothed belts 55a, 55b, 56a, 56b and thus counter-clockwise rotation of driven wheel halves 31a, 31b and driven wheel halves 32a, 32b and therefore counter-clockwise rotation of spline helical cut driven shaft 30.

The spline helical cuts are such that counter-clockwise rotation of spline helical cut driven shaft 30 cause first one-piece pair 35 of driven wheels and second one-piece pair 36 of driven wheels to move axially as units towards one another on spline helical cut driven shaft 30 and push tightly together against thrust bearing 65.

As discussed in conjunction with FIGS. 4 to 6, the first pair 25 of drive wheel halves balances with the first one-piece pair 35 of driven wheel halves and the second pair 26 of drive wheel halves balances with the second one-piece pair 36 of driven wheel halves. If first one-piece pair 35 of driven wheel halves is more heavily loaded than second one-piece pair of 36 of driven wheel halves, first one-piece pair 35 of driven wheels pushes as a unit to the right pushing second one-piece pair 36 of driven wheel halves as a unit to the right to achieve balanced load. If second pair 36 of driven wheel halves is more heavily loaded, the opposite occurs. Balance load is obtained between all drive wheel halves and driven wheels halves for the only two pair of drive wheels and only two pair of driven wheels. FIG. 11 schematically illustrates the condition of balanced load sharing.

It will be appreciated that the spline helical cut drive shaft could be rotated in the clockwise direction with the sense or hand of helical cut splines reversed and the described principle of operation would be the same. Likewise, it will be appreciated that the two pair of drive wheels could each be mounted on the spline helical cut drive shaft as one-piece pairs and the two pair driven wheels could each be mounted on the spline helical cut driven shaft as previously described in conjunction with FIGS. 4 to 6. The described principal of operation would be the same.

The present invention provides for a commercially practical cost-effective belt/chain drive system having multiple drive wheels mounted on a common spline helical cut drive shaft and multiple driven wheels mounted on a common spline helical cut driven shaft. The drive/driven wheels, the spline helical cut drive shaft and spline helical cut driven shaft, and closed loop belt/chain used in the present invention need only have commercially practical, cost-effective manufacturing tolerances.

Although preferred embodiments of the present invention have been described in detail, it is apparent that modifications may be made by those skilled in the art within the spirit and scope of the present invention defined in the claims.

What is claimed is:

1. A belt/chain drive system comprising:
a drive shaft having a first end, a second end and an axis;
a driven shaft disposed parallel to said drive shaft, said driven shaft having a first end, a second end and an axis, wherein the axis of said driven shaft is parallel to the axis of said drive shaft;
at least one set of drive wheels and driven wheels, said set of drive wheels and driven wheels comprising:
a pair of drive wheels mounted on said drive shaft for rotation by said drive shaft and further mounted on said drive shaft for axial movement on said drive shaft;
a pair of driven wheels mounted on said driven shaft for rotating said driven shaft;
said pair of drive wheels comprising a first drive wheel half and a second drive wheel half;
said pair of driven wheels comprising a first driven wheel half and a second driven wheel half;
a first closed loop belt/chain engaging an outer diameter of said first drive wheel half and engaging an outer diameter of said first driven wheel half for rotating said first driven wheel half in response to rotation of said first drive wheel half;
a second closed loop belt/chain engaging an outer diameter of said second drive wheel half and engaging an outer diameter of said second driven wheel half for rotating said second driven wheel half in response to rotation of said second drive wheel half;
said first drive wheel half being a first cylindrical member having a first helical cut spline provided on an inner diameter of said first drive wheel half cylindrical member, with said inner diameter first helical cut spline of said first drive wheel half cylindrical member engaging a first helical cut spline provided on an outer diameter of said drive shaft for rotation of said first drive wheel half by rotation of said drive shaft and for permitting axial movement of said first drive wheel half on said drive shaft;
said second drive wheel half being a second cylindrical member having a second helical cut spline provided on an inner diameter of said second drive wheel half cylindrical member, with said inner diameter second helical cut spline of said second drive wheel half cylindrical member engaging a second helical cut spline provided on an outer diameter of said drive shaft for rotation of said second drive wheel half by rotation of said drive shaft and for permitting axial movement of said second drive wheel half on said drive shaft;
wherein said helical cut splines are selected whereby said first drive wheel half and said second drive wheel half of said set move axially on said drive shaft toward one another on said drive shaft in response to rotation of said drive shaft.

2. A belt/chain drive system according to claim 1 further comprising:
a thrust bearing mounted on said drive shaft for axial movement on said drive shaft, said thrust bearing located on said drive shaft between said first drive wheel half and said second drive wheel half of said set.

3. A belt/chain drive system according to claim 1 further comprising:
said first driven wheel half being a first cylindrical member having a first helical cut spline provided on an inner diameter of said first driven wheel half cylindrical member, with said inner diameter first helical cut spline of said first driven wheel half cylindrical member engaging a first helical cut spline provided on an outer diameter of said driven shaft for rotation of said driven shaft by rotation of said first driven wheel half and for permitting axial movement of said first driven wheel half on said driven shaft;
said second driven wheel half being a second cylindrical member having a second helical cut spline provided on an inner diameter of said second driven wheel half cylindrical member, with said inner diameter second helical cut spline of said second driven wheel half cylindrical member engaging a second helical cut spline provided on an outer diameter of said driven shaft for rotation of said driven shaft by rotation of said second driven wheel half and for permitting axial movement of said second driven wheel half on said driven shaft;
wherein said helical cut splines are selected whereby said first driven wheel half and said second driven wheel half of said set move axially away from one another on said driven shaft in response to rotation of said driven shaft.

4. A belt/chain drive system according to claim 3 further comprising:
a first retainer member located at a fixed axial location on said driven shaft adjacent said first end of said driven shaft and a second retainer member located at a fixed axial location on said driven shaft adjacent said second end of said driven shaft, with said driven wheel halves located on said driven shaft between said first and second retainer members of said driven shaft;
said driven shaft first and second retainer members being spaced from one another at a distance in the axial direction of said driven shaft to permit axial movement of said driven wheel halves of said set away from one another on said driven shaft in the axial direction of said driven shaft and to prevent said driven wheel halves of said set from disengaging respective helical cut splines on said driven shaft.

5. A belt/chain drive system comprising:
a drive shaft having a first end, a second end and an axis;
a driven shaft disposed parallel to said drive shaft, said driven shaft having a first end, a second end and an axis, wherein the axis of said driven shaft is parallel to the axis of said drive shaft;
at least one set of drive wheels and driven wheels, said set of drive wheels and driven wheels comprising:
a pair of drive wheels mounted on said drive shaft for rotation by said drive shaft;
a pair of driven wheels mounted on said driven shaft for rotating said driven shaft and further mounted on said driven shaft for axial movement on said driven shaft;
said pair of drive wheels comprising a first drive wheel half and a second drive wheel half;
said pair of driven wheels comprising a first driven wheel half and a second driven wheel half;
a first closed loop belt/chain engaging an outer diameter of said first drive wheel half and engaging an outer diameter of said first driven wheel half for rotating said first driven wheel half in response to rotation of said first drive wheel half;
a second closed loop belt/chain engaging an outer diameter of said second drive wheel half and engaging an outer diameter of said second driven wheel half for rotating said second driven wheel half in response to rotation of said second drive wheel half;
said first driven wheel half being a first cylinder member having a first helical cut spline provided on an inner diameter of said first driven wheel half cylindrical member, with said inner diameter first helical cut spline of said first driven wheel half cylindrical member engaging a first helical cut spline provided on an outer diameter of said driven shaft for rotation of said driven shaft by rotation of said first driven wheel half and for permitting axial movement of said first driven wheel half on said driven shaft;
said second driven wheel half being a second cylindrical member having a second helical cut spline provided on an inner diameter of said second driven wheel half cylindrical member, with said inner diameter second helical cut spline of said second driven wheel half cylindrical member engaging a second helical cut spline provided on an outer diameter of said driven shaft for rotation of said driven shaft by rotation of said second driven wheel half and for permitting axial movement of said second driven wheel half on said driven shaft;
wherein said helical cut splines are selected whereby said first driven wheel half and said second driven wheel half of said set move axially on said driven shaft toward one another on said driven shaft in response to rotation of said driven shaft.

6. A belt/chain drive system according to claim 5 further comprising:
a thrust bearing mounted on said driven shaft for axial movement on said driven shaft, said thrust bearing located on said driven shaft between said first driven wheel half and said second driven wheel half of said set.

7. A belt/chain drive system according to claim 5 further comprising:
said first drive wheel half being a first cylindrical member having a first helical cut spline provided on an inner diameter of said first drive wheel half cylindrical member, with said inner diameter first helical cut spline of said first drive wheel half cylindrical member engaging a first helical cut spline provided on an outer diameter of said drive shaft for rotation of said first drive wheel half by rotation of said drive shaft and for permitting axial movement of said first drive wheel half on said drive shaft;
said second drive wheel half being a second cylindrical member having a second helical cut spline provided on an inner diameter of said second drive wheel half cylindrical member, with said inner diameter second helical cut spline of said second drive wheel half cylindrical member engaging a second helical cut spline provided on an outer diameter of said drive shaft for rotation of said second drive wheel half by rotation of said drive shaft and for permitting axial movement of said second drive wheel half on said drive shaft;
wherein said helical cut splines are selected whereby said first drive wheel half and said second drive wheel half of said set move axially away from one another on said drive shaft in response to rotation of said drive shaft.

8. A belt/chain drive system according to claim 7 further comprising:
a first retainer member located at a fixed axial location on said drive shaft adjacent said first end of said drive shaft and a second retainer member located at a fixed axial location on said drive shaft adjacent said second end of said drive shaft with said drive wheel halves located on said drive shaft between said first and second retainer members of said drive shaft;
said drive shaft first and second retainer members being spaced from one another at a distance in the axial direction of said drive shaft to permit axial movement of said drive wheel halves of said set away from one another on said drive shaft in the axial direction of said drive shaft and to prevent said drive wheel halves of said set from disengaging respective helical cut spline on said drive shaft.

9. A belt/chain drive system comprising:
a drive shaft having a first end, a second end and an axis;
a driven shaft disposed parallel to said drive shaft, said driven shaft having a first end, a second end and an axis, wherein the axis of said driven shaft is parallel to the axis of said drive shaft;
at least two sets of drive wheels and driven wheels, each set of drive wheels and driven wheels comprising:
a pair of drive wheels mounted on said drive shaft for rotation by said drive shaft and further mounted on said drive shaft for axial movement on said drive shaft;
a pair of driven wheels mounted on said driven shaft for rotating said driven shaft;
said pair of drive wheels of each set comprising a first drive wheel half and a second drive wheel half;
said pair of driven wheels of each set comprising a first driven wheel half and a second driven wheel half;
a first closed loop belt/chain engaging an outer diameter of said first drive wheel half of each set and engaging an outer diameter of said first driven wheel half of each set for rotating said first driven wheel half of each set in response to rotation of said first drive wheel half of each set;
a second closed loop belt/chain engaging an outer diameter of said second drive wheel half of each set and engaging an outer diameter of said second driven wheel half of each set for rotating said second driven wheel half of each set in response to rotation of said second drive wheel half of each set;
said first drive wheel half of each set being a first cylindrical member having a first helical cut spline provided on an inner diameter of said first drive wheel half cylindrical member, with said inner diameter first helical cut spline of said first drive wheel half cylindrical member engaging a first helical cut spline provided on an outer diameter of said drive shaft for rotation of said first drive wheel half by rotation of said drive shaft and for permitting axial movement of said first drive wheel half on said drive shaft;
said second drive wheel half of each set being a second cylindrical member having a second helical cut spline provided on an inner diameter of said second drive wheel half cylindrical member, with said inner diameter second helical cut spline of said second drive wheel half cylindrical member engaging a second helical cut spline provided on an outer diameter of said drive shaft for rotation of said second drive wheel half by rotation of said drive shaft and for permitting axial movement of said second drive wheel half on said drive shaft;
wherein said helical cut splines are selected whereby said first drive wheel half of each set and said second drive wheel half of each set move axially on said drive shaft toward one another on said drive shaft in response to rotation of said drive shaft.

10. A belt/chain drive system according to claim 9 further comprising:
a thrust bearing mounted on said drive shaft for axial movement on said drive shaft, said thrust bearing located on said drive shaft between said first drive wheel half and said second drive wheel half of each set.

11. A belt/chain drive system according to claim 9 further comprising:
said first driven wheel half of each set being a first cylindrical member having a first helical cut spline provided on an inner diameter of said first driven wheel half cylindrical member, with said inner diameter first helical cut spline of said first driven wheel half cylindrical member engaging a first helical cut spline provided on an outer diameter of said driven shaft for rotation of said driven shaft by rotation of said first driven wheel half and for permitting axial movement of said first driven wheel half on said driven shaft;
said second driven wheel half of each set being a second cylindrical member having a second helical cut spline provided on an inner diameter of said second driven wheel half cylindrical member, with said inner diameter second helical cut spline of said second driven wheel half cylindrical member engaging a second helical cut spline provided on an outer diameter of said driven shaft for rotation of said driven shaft by rotation of said second driven wheel half and for permitting axial movement of said second driven wheel half on said driven shaft;
wherein said helical cut splines are selected whereby said first driven wheel half of each set and said second driven wheel half of each set move axially away from one another on said driven shaft in response to rotation of said driven shaft.

12. A belt/chain drive system according to claim 11 further comprising:
a first retainer member located at a fixed axial location on said driven shaft adjacent said first end of said driven shaft and a second retainer member located at a fixed axial location on said driven shaft adjacent said second end of said driven shaft, with said driven wheel halves of each set located on said driven shaft between said first and second retainer members of said driven shaft;
said driven shaft first and second retainer members being spaced from one another at a distance in the axial direction of said driven shaft to permit axial movement of said driven wheel halves of each set away from one another on said driven shaft in the axial direction of said driven shaft and to prevent said driven wheel halves of each set from disengaging respective helical cut splines on said driven shaft.

13. A belt/chain drive system according to claim 12 further comprising:
two sets of drive wheels and driven wheels comprising:
a first set of drive wheels and driven wheels comprising a first pair of drive wheel halves and a first pair of driven wheel halves;
a second set of drive wheels and driven wheels comprising a second pair of drive wheel halves and a second pair of driven wheel halves;
the first driven wheel half of said first pair of driven wheel halves mounted on said driven shaft adjacent to said first retainer member located at the fixed axial location on said driven shaft;
the second driven wheel half of said second pair of driven wheel halves mounted on said driven shaft adjacent to said second retainer member located at the fixed axial location on said driven shaft;
the second driven wheel half of said first pair of driven wheel halves mounted on said driven shaft adjacent the first driven wheel half of said second pair of driven wheel halves mounted on said driven shaft;
a thrust bearing mounted on said driven shaft for axial movement on said driven shaft, said thrust bearing located on said driven shaft between the second driven wheel half of said first pair of driven wheel halves and the first driven wheel half of said second pair of driven wheel halves.

14. A belt/chain drive system according to claim 12 further comprising:
at least three sets of drive wheels and driven wheels comprising:
a first set of drive wheels and driven wheels comprising a first pair of drive wheel halves and a first pair of driven wheel halves;
a second set of drive wheels and driven wheels comprising a second pair of drive wheel halves and a second pair of driven wheel halves;
a third set of drive wheels and driven wheels comprising a third pair of drive wheel halves and a third pair of driven wheel halves;
the second driven wheel half of said first pair of driven wheel halves mounted on said driven shaft adjacent the first wheel driven gear half of said second pair of driven wheel halves mounted on said driven shaft;
a thrust bearing mounted on said driven shaft for axial movement of said thrust bearing on said driven shaft, said thrust bearing located on said driven shaft between the second driven wheel half of said first pair of driven wheel halves and the first driven wheel half of said second pair of driven wheel halves;
the second driven wheel half of said second pair of driven wheel halves mounted on said driven shaft adjacent the first driven wheel half of said third pair of driven gear halves mounted on said driven shaft;
another thrust bearing mounted on said driven shaft for axial movement of said another thrust bearing on said driven shaft, said another thrust bearing located on said driven shaft between the second driven wheel half of said second pair of driven wheel halves and the first driven wheel half of said third pair of driven wheel halves.

15. A belt/chain drive system comprising:
a drive shaft having a first end, a second end and an axis;
a driven shaft disposed parallel to said drive shaft, said driven shaft having a first end, a second end and an axis, wherein the axis of said driven shaft is parallel to the axis of said drive shaft;
at least two sets of drive wheels and driven wheels, each set of drive wheels and driven wheels comprising:
a pair of drive wheels mounted on said drive shaft for rotation by said drive shaft;
a pair of driven wheels mounted on said driven shaft for rotating said driven shaft and further mounted on said driven shaft for axial movement on said driven shaft;
said pair of drive wheels of each set comprising a first drive wheel half and a second drive wheel half;
said pair of driven wheels of each set comprising a first driven wheel half and a second driven wheel half;
a first closed loop belt/chain engaging an outer diameter of said first drive wheel half of each set and engaging an outer diameter of said first driven wheel half of each set for rotating said first driven wheel half of each set in response to rotation of said first drive wheel half of each set;
a second closed loop belt/chain engaging an outer diameter of said second drive wheel half of each set and engaging an outer diameter of said second driven wheel half of each set for rotating said second driven wheel half of each set in response to rotation of said second drive wheel half of each set;
said first driven wheel half of each set being a first cylindrical member having a first helical cut spline provided on an inner diameter of said first driven wheel half cylindrical member, with said inner diameter first helical cut spline of said first driven wheel half cylindrical member engaging a first helical cut spline provided on an outer diameter of said driven shaft for rotation of said driven shaft by rotation of said first driven wheel half and for permitting axial movement of said first driven wheel half on said driven shaft;
said second driven wheel half of each set being a second cylindrical member having a second helical cut spline provided on an inner diameter of said second driven wheel half cylindrical member, with said inner diameter second helical cut spline of said second driven wheel half cylindrical member engaging a second helical cut spline provided on an outer diameter of said driven shaft for rotation of said driven shaft by rotation of said second driven wheel half and for permitting axial movement of said second driven wheel half on said driven shaft;
wherein said helical cut splines are selected whereby said first driven wheel half of each set and said second driven wheel half of each set move axially on said driven shaft toward one another on said driven shaft in response to rotation of said driven shaft.

16. A belt/chain drive system according to claim 15 further comprising:
a thrust bearing mounted on said driven shaft for axial movement on said driven shaft, said thrust bearing located on said driven shaft between said first driven wheel half and said second driven wheel half of each set of drive wheels and driven wheels.

17. A belt/chain drive system according to claim 15 further comprising:
said first drive wheel half of each set being a first cylindrical member having a first helical cut spline provided on an inner diameter of said first drive wheel half cylindrical member, with said inner diameter first helical cut spline of said first drive wheel half cylindrical member engaging a first helical cut spline provided on an outer diameter of said drive shaft for rotation of said first drive wheel half by rotation of said drive shaft and for permitting axial movement of said first drive wheel half on said drive shaft;
said second drive wheel half of each set being a second cylindrical member having a second helical cut spline provided on an inner diameter of said second drive wheel half cylindrical member, with said inner diameter second helical cut spline of said second drive wheel half cylindrical member engaging a second helical cut spline provided on an outer diameter of said drive shaft for rotation of said second drive wheel half by rotation of said drive shaft and for permitting axial movement of said second drive wheel half on said drive shaft;
wherein said helical cut splines are selected whereby said first drive wheel half of each set and said second drive wheel half of each set move axially away from one another on said drive shaft in response to rotation of said drive shaft.

18. A belt/chain drive system according to claim 17 further comprising:
a first retainer member located at a fixed axial location on said drive shaft adjacent said first end of said drive shaft and a second retainer member located at a fixed axial location on said drive shaft adjacent said second end of said drive shaft with said drive wheel halves of each set located on said drive shaft between said first and second retainer members of said drive shaft;
said drive shaft first and second retainer members being spaced from one another at a distance in the axial direction of said drive shaft to permit axial movement of said drive wheel halves of each set on said drive shaft in the axial direction of said drive shaft and to prevent said drive wheel halves of each set from disengaging respective spline helical cuts on said drive shaft.

19. A belt/chain drive system according to claim 18 further comprising:
two sets of drive wheels and driven wheels comprising:
a first set of drive wheels and driven wheels comprising a first pair of drive wheel halves and a first pair of driven wheel halves;
a second set of drive wheels and driven wheels comprising a second pair of drive wheel halves and a second pair of driven wheel halves;
the first drive wheel half of said first pair of drive wheel halves mounted on said drive shaft adjacent to said first retainer member located on said drive shaft;
the second drive wheel half of said second pair of drive wheel halves mounted on said drive shaft adjacent to said second retainer member located on said drive shaft;
the second drive wheel half of said first pair of drive wheel halves mounted on said drive shaft adjacent the first drive wheel half of said second pair of drive wheel halves mounted on said drive shaft;
a thrust bearing mounted on said drive shaft for axial movement of said thrust bearing on said drive shaft, said thrust bearing located on said drive shaft between the second drive wheel half of said first pair of drive wheel halves and the first drive wheel half of said second pair of drive wheel halves.

20. A belt/chain drive system according to claim 18 further comprising:
at least three sets of drive wheels and driven wheels comprising:
a first set of drive wheels and driven wheels comprising a first pair of drive wheel halves and a first pair of driven wheel halves;
a second set of drive wheels and driven wheels comprising a second pair of drive wheel halves and a second pair of driven wheel halves;
a third set of drive wheels and driven wheels comprising a third pair of drive wheel halves and a third pair of driven wheel halves;
the second drive wheel half of said first pair of drive wheel halves mounted on said drive shaft adjacent the first drive wheel half of said second pair of drive wheel halves mounted on said drive shaft;
a thrust bearing mounted on said drive shaft for axial movement of said thrust bearing on said drive shaft, said thrust bearing located on said drive shaft between the second drive wheel half of said first pair of drive wheel halves and the first drive wheel half of said second pair of drive wheel halves;
the second drive wheel half of said second pair of drive wheel halves mounted on said drive shaft adjacent the first drive wheel half of said third pair of drive wheel halves mounted on said drive shaft;
another thrust bearing mounted on said drive shaft for axial movement of said another thrust bearing on said drive shaft, said another thrust bearing located on said drive shaft between the second drive wheel half of said second pair of drive wheel halves and the first drive wheel half of said third pair of drive wheel halves.

21. A belt/chain drive system according to claim 11, comprising a plurality of sets of drive wheels and driven wheels.

22. A belt/chain drive system according to claim 17, comprising a plurality of sets of drive wheels and driven wheels.

23. A belt/chain drive system according to claim 1 further comprising:
one set of drive wheels and driven wheels, said one set of drive wheels and driven wheels comprising:
one pair of drive wheels;
one pair of driven wheels;
wherein said first driven wheel half and said second driven wheel half of said one pair of drive wheels and driven wheels are both mounted on said driven shaft at a fixed axial spaced apart location.

24. A belt/chain drive system according to claim 5 further comprising:
one set of drive wheels and driven wheels, said one set of drive wheels and driven wheels comprising:
one pair of spur drive wheels;
one pair of spur driven wheels;
wherein said first drive wheel half and said second drive wheel half of said one pair of drive wheels and driven wheels are both mounted on said drive shaft at a fixed axial spaced apart location.

25. A belt/chain drive system according to claim 11, further comprising:
two sets of drive wheels and driven wheels;
said spline helical cut drive shaft comprising a first spline helical cut drive shaft part torsionally joined to a second spline helical cut drive shaft part;
said spline helical cut driven shaft comprising a first spline helical cut driven shaft part torsionally joined to a second spline helical cut driven shaft part.

26. A belt/chain drive system according to claim 11, further comprising:
at least three sets of drive wheels and driven wheels;
said spline helical cut drive shaft comprising a first spline helical cut drive shaft part torsionally joined to a second spline helical cut drive shaft part, and said second spline helical cut drive shaft part torsionally joined to a third spline helical cut drive shaft part;
said spline helical cut driven shaft comprising a first spline helical cut driven shaft part torsionally joined to a second spline helical cut driven shaft part, and said second spline helical cut driven shaft part torsionally joined to a third spline helical cut driven shaft part.

27. A belt/chain drive system according to claim 17, further comprising:
two sets of drive wheels and driven wheels;
said spline helical cut drive shaft comprising a first spline helical cut drive shaft part torsionally joined to a second spline helical cut drive shaft part;
said spline helical cut driven shaft comprising a first spline helical cut driven shaft part torsionally joined to a second spline helical cut driven shaft part.

28. A belt/chain drive system according to claim 17, further comprising:
at least three sets of drive wheels and driven wheels;
said spline helical cut drive shaft comprising a first spline helical cut drive shaft part torsionally joined to a second spline helical cut drive shaft part, and said second spline helical cut drive shaft part torsionally joined to a third spline helical cut drive shaft part;
said spline helical cut driven shaft comprising a first spline helical cut driven shaft part torsionally joined to a second spline helical cut driven shaft part, and said second spline helical cut driven shaft part torsionally joined to a third spline helical cut driven shaft part.

29. A belt/chain drive system according to claim 9 further comprising:
two sets of drive wheels and driven wheels comprising a first set of drive wheels and driven wheels and a second set of drive wheels and driven wheels;
said pair of driven wheel halves of said first set of drive wheels and driven wheels mounted as a unit on said driven shaft at a fixed spaced apart axial location with respect to one another and further mounted on a first helical cut spline provided on an outer diameter of said driven shaft for axial movement together as a pair on said driven shaft;
said pair of driven wheel halves of said second set of drive wheels and driven wheels mounted as a unit on said driven shaft at a fixed spaced apart axial location with respect to one another and further mounted on a second helical cut spline provided on said outer diameter of said driven shaft for axial movement together as a pair on said driven shaft;
wherein said first helical cut spline and said second helical cut spline on said outer diameter of said driven shaft are selected whereby said pair of driven wheel halves of said first set of drive wheels and driven wheels and said pair of driven wheel halves of said second set of drive wheels and driven wheels move axially on said driven shaft toward one another in response to rotation of said driven shaft.

30. A belt/chain drive system according to claim 15 further comprising:
two sets of drive wheels and driven wheels comprising a first set of drive wheels and driven wheels and a second set of drive wheels and driven wheels;
said pair of drive wheel halves of said first set of drive wheels and driven wheels mounted as a unit on said drive shaft at a fixed spaced apart axial location with respect to one another and further mounted on a first helical cut spline provided on an outer diameter of said drive shaft for axial movement together as a pair on said drive shaft;
said pair of drive wheel halves of said second set of drive wheels and driven wheels mounted as a unit on said drive shaft at a fixed spaced apart axial location with respect to one another and further mounted on a second helical cut spline provided on said outer diameter of said drive shaft for axial movement together as a pair on said drive shaft;
wherein said first helical cut spline and said second helical cut spline on said outer diameter of said drive shaft are selected whereby said pair of drive wheel halves of said first set of drive wheels and driven wheels and said pair of drive wheel halves of said second set of drive wheels and driven wheels move axially on said drive shaft toward one another in response to rotation of said drive shaft.

31. A belt/chain drive system according to claim 11 further comprising:
outer diameter D1 of the helical cut of the spline on the drive shaft adjacent to the first end of the drive shaft is equal to outer diameter D1A of the helical cut of the spline on the drive shaft adjacent to the second end of the drive shaft;
outer diameter D2 of the helical cut of the spline on the drive shaft adjacent to the helical cut of the spline on the drive shaft having outer diameter D1 is equal to outer diameter D2A of the helical cut of the spline on the drive shaft adjacent to the helical cut of the spline on the drive shaft having outer diameter D1A;
wherein outer diameter D2 is greater than outer diameter D1; and
wherein outer diameter D2A is greater than outer diameter D1A.

32. A belt/chain drive system according to claim 31 further comprising:
at least three sets of drive wheels and driven wheels;
outer diameter D3 of the helical cut of the spline on the drive shaft adjacent to the helical cut of the spline on the drive shaft having outer diameter D2 is equal to outer diameter D3A of the helical cut of the spline on the drive shaft adjacent to the helical cut of the spline on the drive shaft having outer diameter D2A;
wherein outer diameter D3 is greater than outer diameter D2; and
wherein outer diameter D3A is greater than outer diameter D2A.

33. A belt/chain drive system according to claim 31 further comprising:
outer diameter D1 of the helical cut of the spline on the driven shaft adjacent to the first end of the driven shaft is equal to outer diameter D1A of the helical cut of the spline on the driven shaft adjacent to the second end of the driven shaft;
outer diameter D2 of the helical cut of the spline on the driven shaft adjacent to the helical cut of the spline on the driven shaft having outer diameter D1 is equal to outer diameter D2A of the helical cut of the spline on the driven shaft adjacent to the helical cut of the spline on the driven shaft having outer diameter D1A;
wherein outer diameter D2 is greater than outer diameter D1; and
wherein outer diameter D2A is greater than outer diameter D1A.

34. A belt/chain drive system according to claim 33 further comprising:
at least three sets of drive wheels and driven wheels;
outer diameter D3 of the helical cut of the spline on the driven shaft adjacent to the helical cut of the spline on the driven shaft having outer diameter D2 is equal to outer diameter D3A of the helical cut of the spline on the driven shaft adjacent to the helical cut of the spline on the driven shaft having outer diameter D2A;
wherein outer diameter D3 is greater than outer diameter D2; and
wherein outer diameter D3A is greater than outer diameter D2A.

35. A belt/chain drive system according to claim 17 further comprising:
outer diameter D1 of the helical cut of the spline on the drive shaft adjacent to the first end of the drive shaft is equal to outer diameter D1A of the helical cut of the spline on the drive shaft adjacent to the second end of the drive shaft;
outer diameter D2 of the helical cut of the spline on the drive shaft adjacent to the helical cut of the spline on the drive shaft having outer diameter D1 is equal to outer diameter D2A of the helical cut of the spline on the drive shaft adjacent to the helical cut of the spline on the drive shaft having outer diameter D1A;
wherein outer diameter D2 is greater than outer diameter D1; and
wherein outer diameter D2A is greater than outer diameter D1A.

36. A belt/chain drive system according to claim 35 further comprising:
at least three sets of drive wheels and driven wheels;
outer diameter D3 of the helical cut of the spline on the drive shaft adjacent to the helical cut of the spline on the drive shaft having outer diameter D2 is equal to outer diameter D3A of the helical cut of the spline on the drive shaft adjacent to the helical cut of the spline on the drive shaft having outer diameter D2A;
wherein outer diameter D3 is greater than outer diameter D2; and
wherein outer diameter D3A is greater than outer diameter D2A.

37. A belt/chain drive system according to claim 35 further comprising:
outer diameter D1 of the helical cut of the spline on the driven shaft adjacent to the first end of the driven shaft is equal to outer diameter D1A of the helical cut of the spline on the driven shaft adjacent to the second end of the driven shaft;
outer diameter D2 of the helical cut of the spline on the driven shaft adjacent to the helical cut of the spline on the driven shaft having outer diameter D1 is equal to outer diameter D2A of the helical cut of the spline on the driven shaft adjacent to the helical cut of the spline on the driven shaft having outer diameter D1A;
wherein outer diameter D2 is greater than outer diameter D1; and
wherein outer diameter D2A is greater than outer diameter D1A.

38. A belt/chain drive system according to claim 37 further comprising:
at least three sets of drive wheels and driven wheels;
outer diameter D3 of the helical cut of the spline on the driven shaft adjacent to the helical cut of the spline on the driven shaft having outer diameter D2 is equal to outer diameter D3A of the helical cut of the spline on the driven shaft adjacent to the helical cut of the spline on the driven shaft having outer diameter D2A;
wherein outer diameter D3 is greater than outer diameter D2; and
wherein outer diameter D3A is greater than outer diameter D2A.

39. A method for transmitting load in a belt/chain drive system comprising:
providing a drive shaft and a driven shaft;
mounting at least a first pair of drive wheels on said drive shaft and providing a helical cut spline on an inner diameter of each drive wheel of said at least first pair of drive wheels for rotational movement of said at least first pair of drive wheels by said drive shaft and for axial movement of said at least first pair of drive wheels on said drive shaft;
mounting at least a first pair of driven wheels on said driven shaft for rotation of said driven shaft by said at least first pair of driven wheels;
engaging said at least first pair of drive wheels with said at least first pair of driven wheels via a pair of closed loop belts/chains;
providing said drive shaft with a first helical cut spline on an outer diameter of said drive shaft engaging the helical cut spline on the inner diameter of one drive wheel of said at least first pair of drive wheels and providing said drive shaft with a second helical cut spline on the outer diameter of said drive shaft engaging the helical cut spline on the inner diameter of the other drive wheel of said at least first pair of drive wheels;
said helical cut splines selected whereby rotating said drive shaft results in causing said one drive wheel and said other drive wheel of said at least first pair of drive wheels to axially move on said drive shaft toward one another resulting in balanced load transmission between each drive wheel of said at least first pair of drive wheels and each driven wheel of said at least first pair of driven wheels.

40. A method for transmitting load in a belt/chain drive system according to claim 39 further comprising:
providing a helical cut spline on an inner diameter of each driven wheel of said at least first pair of driven wheels for rotating said driven shaft by said at least first pair of driven wheels and for axial movement of said at least first pair of driven wheels on said driven shaft;
providing said driven shaft with a first helical cut spline on the outer diameter of said driven shaft engaging the helical cut spline on the inner diameter of one driven wheel of said at least first pair of driven wheels and providing said driven shaft with a second helical cut spline on the outer diameter of said driven shaft engaging the helical cut spline on the inner diameter of the other driven wheel of said at least first pair driven wheels;
said helical cut splines selected whereby rotating said driven shaft results in causing said one driven wheel and said other driven wheel of said at least one pair of driven wheels to axially move on said driven shaft away from one another.

41. A method for transmitting load in a belt/chain drive system according to claim 39 further comprising:
mounting two pair of drive wheels on said drive shaft;
mounting two pairs of driven wheels on said driven shaft;
engaging each drive wheel of each pair of drive wheels with a respective driven wheel of each pair of driven wheels via closed loop belts/chains;
further mounting each driven wheel of each pair of driven wheels on said driven shaft at a fixed axial spaced apart location with respect to one another and further mounting each pair of driven wheels on said driven shaft by respective helical cut splines on an outer diameter of said driven shaft for axial movement together of each pair of driven wheels on said driven shaft;
rotating said drive and driven shaft causing each pair of driven wheels to axially move together toward one another on said driven shaft;
said rotating said drive shaft and said driven shaft resulting in balanced load transmission among each drive wheel of each pair of drive wheels and each driven wheel of each pair of driven wheels.

42. A method for transmitting load in a belt/chain drive system according to claim 40 further comprising:
providing at least two pair of drive wheels and at least two pair of driven wheels;
providing a helical cut spline on an inner diameter of each drive wheel of each pair of drive wheels engaging a respective helical cut spline provided on the outer diameter of said drive shaft;
providing a helical cut spline on an inner diameter of each driven wheel of each pair of driven wheels engaging a respective helical cut spline provided on the outer diameter of said driven shaft;
said helical cut splines selected whereby rotating said drive shaft and said driven shaft results in causing axial movement of each drive wheel of each pair of drive wheels on said drive shaft toward one another and in causing axial movement of each driven wheel of each pair of driven wheels on said driven shaft away from one another resulting in balanced load transmission among each drive wheel and each driven wheel.

43. A method for transmitting load in a belt/chain drive system comprising:
providing a drive shaft and a driven shaft;
mounting at least a first pair of driven wheels on said driven shaft and providing a helical cut spline on an inner diameter of each driven wheel of said at least first pair of driven wheels for rotation of said driven shaft by said at least first pair of driven wheels and for axial movement of said at least first pair of driven wheels on said driven shaft;
mounting at least first pair of drive wheels on said drive shaft for rotation by said drive shaft;
engaging said at least first pair of drive wheels with said at least first pair of driven wheels via a pair of closed loop belts/chains;
providing said driven shaft with a first helical cut spline on an outer diameter of said driven shaft engaging the helical cut spline on the inner diameter of one driven wheel of said at least first pair of driven wheels and providing said driven shaft with a second helical cut spline on the outer diameter of said driven shaft engaging the helical cut spline on the inner diameter of the other driven wheel of said at least first pair of driven wheels;
said helical cut splines selected whereby rotating said driven shaft results in causing said one driven wheel and said other driven wheel of said at least first pair of driven wheels to axially move on said driven shaft toward one another resulting in balanced load transmission between each driven wheel of said at least first pair of driven wheels and each drive wheel of said at least first pair of drive wheels.

44. A method for transmitting load in a belt/chain drive system according to claim 43 further comprising:
providing a helical cut spline on an inner diameter of each drive wheel of said at least first pair of drive wheels for rotation by said drive shaft of said at least first pair of drive wheels and for axial movement of said at least first pair of drive wheels on said drive shaft;
providing said drive shaft with a first helical cut spline on the outer diameter of said drive shaft engaging the helical cut spline on the inner diameter of one drive wheel of said at least first pair of drive wheels and providing said drive shaft with a second helical cut spline on the outer diameter of said drive shaft engaging the helical cut spline on the inner diameter of the other drive wheel of said at least first pair drive wheels;
said helical cut splines selected whereby rotating said drive shaft results in causing said one drive wheel and said other drive wheel of said at least one pair of drive wheels to axially move on said drive shaft away from one another.

45. A method for transmitting load in a belt/chain drive system according to claim 43 further comprising:
mounting two pair of drive wheels on said drive shaft;
mounting two pairs of driven wheels on said driven shaft;
engaging each drive wheel of each pair of drive wheels with a respective driven wheel of each pair of driven wheels via closed loop belts/chains;
further mounting each drive wheel of each pair of drive wheels on said drive shaft at a fixed axial spaced apart location with respect to one another and further mounting each pair of drive wheels on said drive shaft by respective helical cut splines on an outer diameter of said drive shaft for axial movement together of each pair of drive wheels on said drive shaft;
rotating said drive and driven shaft causing each pair of drive wheels to axially move together toward one another on said drive shaft;
said rotating said drive shaft and said driven shaft resulting in balanced load transmission among each drive wheel of each pair of drive wheels and each driven wheel of each pair of driven wheels.

46. A method for transmitting load in a belt/chain drive system according to claim 44 further comprising:
providing at least two pair of drive wheels and at least two pair of driven wheels;
providing a helical cut spline on an inner diameter of each drive wheel of each pair of drive wheels engaging a respective helical cut spline provided on the outer diameter of said drive shaft;
providing a helical cut spline on an inner diameter of each driven wheel of each pair of driven wheels engaging a respective helical cut spline provided on the outer diameter of said driven shaft;
said helical cut splines selected whereby rotating said drive shaft and said driven shaft results in causing axial movement of each drive wheel of each pair of drive wheels on said drive shaft away from one another and in causing axial movement of each driven wheel of each pair of driven wheels on said driven shaft toward one another resulting in balanced load transmission among each drive wheel and each driven wheel.

47. A method for transmitting load in a belt/chain drive system according to claim 39 further comprising:
mounting one pair of drive wheels on said drive shaft;
mounting one pair of driven wheels on said driven shaft;
further mounting each driven wheel of said one pair of driven wheels on said driven shaft at a fixed axially spaced apart location on said driven shaft.

48. A method for transmitting load in a belt/chain drive system according to claim 43 further comprising:
mounting one pair of drive wheels on said drive shaft;
mounting one pair of driven wheels on said driven shaft;
further mounting each drive wheel of said one pair of drive wheels on said drive shaft at a fixed axially spaced apart location on said drive shaft.
